(19) United States
(12) Patent Application Publication
(10) Pub. No.: US 2024/0309526 A1
(43) Pub. Date: Sep. 19, 2024

(54) PEROVSKITE-BASED NANOCOMPOSITE (PTNC) MATERIAL-BASED ELECTRODE AND METHOD OF PREPARATION THEREOF FOR ELECTROCATALYTIC HYDROGEN EVOLUTION REACTION

(71) Applicant: KING FAHD UNIVERSITY OF PETROLEUM AND MINERALS, Dhahran (SA)

(72) Inventors: Mohamed Jaffer Sadiq MOHAMED, Dhahran (SA); Muhammad Ashraf GONDAL, Dhahran (SA)

(73) Assignee: KING FAHD UNIVERSITY OF PETROLEUM AND MINERALS, Dhahran (SA)

(21) Appl. No.: 18/185,166

(22) Filed: Mar. 16, 2023

(51) Int. Cl. C25B 11/093; C25B 1/04; C25B 11/052; C25B 11/067

(52) U.S. Cl. CPC C25B 11/093; C25B 1/04; C25B 11/052; C25B 11/067

(57) ABSTRACT

An electrode including a transparent substrate and a layer of a perovskite-based nanocomposite (PTNC) material at least partially covering a surface of the transparent substrate. The PTNC material includes gold (Au) nanoparticles, graphitic carbon nitride (g-C₃N₄) nanoparticles, and perovskite-based nanoparticles through synergistic interaction. A method of making the electrode is described.

### BACKGROUND

### Technical Field

The present disclosure is directed to an electrode, particularly, to a perovskite-based nanocomposite (PTNC) material-based electrode, and a method of preparing the same for electrocatalytic hydrogen evolution reaction (EHER).

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The energy crisis and environmental issues are ever-growing concerns to humanity [W. Yang, S. Chen, Recent progress in electrode fabrication for electrocatalytic hydrogen evolution reaction: A mini review, Chemical Engineering Journal. 393 (2020) 124726; M. Zeng, Y. Li, Recent advances in heterogeneous electrocatalysts for the hydrogen evolution reaction, J Mater Chem a Mater. 3 (2015) 14942-14962; G. Zhao, K. Rui, S. X. Dou, W. Sun, Heterostructures for electrochemical hydrogen evolution reaction: a review, Adv Funct Mater. 28 (2018) 1803291]. To solve such problems, an eco-accommodating, sustainable, and practical fuel source that can trade the unexceptionally utilized nuclear and fossil fuel is demanded worldwide [P. Aggarwal, D. Sarkar, K. Awasthi, P. W. Menezes, Functional role of single-atom catalysts in electrocatalytic hydrogen evolution: Current developments and future challenges, Coord Chem Rev. 452 (2022) 214289; A. Raza, K. M. Deen, E. Asselin, W. Haider, A review on the electrocatalytic dissociation of water over stainless steel: Hydrogen and oxygen evolution reactions, Renewable and Sustainable Energy Reviews. 161 (2022) 112323].

Hydrogen, an inexhaustible and clean fuel is considered a potential candidate for future energy transports [L. E. Klebanoff, S. A. M. Caughlan, R. T. Madsen, C. J. Conard, T. S. Leach, T. B. Appelgate, Comparative study of a hybrid research vessel utilizing batteries or hydrogen fuel cells, Int J Hydrogen Energy. 46 (2021) 38051-38072; D. D. T. Ferraren-De Cagalitan, M. L. S. Abundo, A review of biohydrogen production technology for application towards hydrogen fuel cells, Renewable and Sustainable Energy Reviews. 151 (2021) 111413]. The electrocatalytic splitting of water is a strategy for hydrogen creation with high energy change proficiency. Furthermore, the use of electrolytic tools to produce hydrogen is typically associated with properties having mechanical interests [Y. Gong, J. Yao, P. Wang, Z. Li, H. Zhou, C. Xu, Perspective of hydrogen energy and recent progress in electrocatalytic water splitting, Chin J Chem Eng. 43 (2022) 282-296; L. Chen, J.-T. Ren, Z.-Y. Yuan, Design strategies of phosphorus-containing catalysts for photocatalytic, photoelectrochemical, and electrocatalytic water splitting, Green Chemistry. 24 (2022) 713-747].

In any modern electrolysis, properties such as high surface area, electrochemical stability, reasonable electrical properties, low hydrogen over-potential, efficient electrocatalytic action, and high corrosion resistance of an electrode are considered for water electrolysis [B. Talluri, K. Yoo, J. Kim, Lanthanum oxide rods as a novel and efficient bifunctional hydrogen and oxygen evolution electrocatalyst for overall water splitting, Ceram Int. (2022); W. Yu, Y. Gao, Z. Chen, Y. Zhao, Z. Wu, L. Wang, Strategies on improving the electrocatalytic hydrogen evolution performances of metal phosphides, Chinese Journal of Catalysis. 42 (2021) 1876-1902; X. Fu, R. Shi, S. Jiao, M. Li, Q. Li, Structural design for electrocatalytic water splitting to realize industrial-scale deployment: Strategies, advances, and perspectives, Journal of Energy Chemistry. 70 (2022) 129-153]. Such properties can be tuned using controlled synthesis techniques and doping or compositing with other suitable materials. In short, high-performance catalysts as cathode material are needed for the improved EHER.

Currently, cutting-edge catalysts are based on precious metals such as platinum (Pt) due to their low over-potential and efficient kinetics for driving EHER [M. v Kaneva, L. B. Gulina, V. P. Tolstoy, Pt nanoparticles synthesized by successive ionic layers deposition method and their electrocatalytic properties in hydrogen evolution reaction during water splitting in the acidic medium, J Alloys Compd. 901 (2022) 163640]. However, the significant downside associated with Pt catalysts is their high cost [M. A. Ehsan, M. H. Suliman, A. Rehman, A. S. Hakeem, A. al Ghanim, M. Qamar, Fabrication of platinum thin films for ultra-high electrocatalytic hydrogen evolution reaction, Int J Hydrogen Energy. 45 (2020) 15076-15085]. To make the production of hydrogen a viable option, it is essential to develop some cost-effective alternatives that can compete favorably well with the electrocatalytic activity of Pt electrodes [G. Gao, L. Chen, R. Zhang, B. Xu, Y.-X. Li, X. L. Wang, Y.-F. Yao, Photo-controlled chemical states and the optimal size of Pt for enhancing the photo- and electrocatalytic hydrogen evolution reaction, J Alloys Compd. 909 (2022) 164738].

Lately, inorganic perovskite materials have gained renewed interests owing to their promising electrochemical properties. [I. P, M. K. G, S. C, C. H. D, T. S, S. S, K. T. W, K. D. Y, Aid of cobalt ions in boosting the electrocatalytic oxygen and hydrogen evolution functions of NdFeO₃ perovskite nanostructures, Journal of Materials Research and Technology. 11 (2021) 2246-2254; Y. Dou, Y. Xie, X. Hao, T. Xia, Q. Li, J. Wang, L. Huo, H. Zhao, Addressing electrocatalytic activity and stability of LnBaCo₂O_{5+δ} perovskites for hydrogen evolution reaction by structural and electronic features, Appl Catal B. 297 (2021) 120403; X. Liu, L. Yang, Z. Zhou, L. Zeng, H. Liu, Y. Deng, J. Yu, C. Yang, W. Zhou, N doped carbon coated multi-metals nanoparticles decorated perovskite as electrocatalyst for efficient hydrogen evolution reaction, Chemical Engineering Journal. 399 (2020) 125779; Q. Sun, Z. Dai, Z. Zhang, Z. Chen, H. Lin, Y. Gao, D. Chen, Double perovskite PrBaCo₂O_{5.5}: An efficient and stable electrocatalyst for hydrogen evolution reaction, J Power Sources. 427 (2019) 194-200; R. Khan, M. T. Mehran, S. R. Naqvi, A. H. Khoja, M. M. Baig, M. A. Akram, F. Shahzad, S. Hussain, A highly efficient A-site deficient perovskite interlaced within two dimensional MXene nanosheets as an active electrocatalyst for hydrogen production, Int J Hydrogen Energy. (2021); J. Gao, Y. Zhang, X. Wang, L. Jia, H. Jiang, M. Huang, A. Toghan, Nitrogen-doped Sr₂Fe_{1.5}Mo_{0.5}O_{6-δ} perovskite as an efficient and stable catalyst for hydrogen evolution reaction, Mater Today Energy. 20 (2021) 100695; X. Xu, Y. Pan, Y. Zhong, L. Ge, S. P. Jiang, Z. Shao, From scheelite BaMoO₄ to perovskite BaMoO₃: Enhanced electrocatalysis toward the hydrogen evolution in alkaline media, Compos B Eng. 198 (2020) 108214; A. Galal, N. F. Atta, S. A. Darwish, A. A. Fatah, S. M. Ali, Electrocatalytic evolution of hydrogen on a novel SrPdO₃ perovskite electrode, J Power Sources. 195 (2010) 3806-3809; Md. S. Alom, C. C. W. Kananke-Gamage, F. Ramezanipour, Perovskite Oxides as Electrocatalysts for Hydrogen Evolution Reaction, ACS Omega. 7 (2022) 7444-7451].

Such materials may include nanostructured two-dimensional (2D) SrTiO₃@MoS₂ [L. Zhang, J. Yin, K. Wei, B. Li, T. Jiao, Y. Chen, J. Zhou, Q. Peng, Fabrication of hierarchical SrTiO₃@MoS₂ heterostructure nanofibers as efficient and low-cost electrocatalysts for hydrogen-evolution reactions, Nanotechnology. 31 (2020) 205604], SrTiFe_{0.9}Pr_{0.1}O_{6-δ} [Q. Sarmad, U. M. Khan, M. M. Baig, M. Hassan, F. A. Butt, A. H. Khoja, R. Liaquat, Z. S. Khan, M. Anwar, M. A. S. A., Praseodymium-doped Sr₂TiFeO_{6-δ} double perovskite as a bi-functional electrocatalyst for hydrogen production through water splitting, J Environ Chem Eng. (2022) 107609], SrTi_{0.7}Ru_{0.3}O_{3-δ} [J. Dai, Y. Zhu, H. A. Tahini, Q. Lin, Y. Chen, D. Guan, C. Zhou, Z. Hu, H.-J. Lin, T.-S. Chan, Single-phase perovskite oxide with super-exchange induced atomic-scale synergistic active centers enables ultrafast hydrogen evolution, Nat Commun. 11 (2020) 1-10], SrTi_{0.1}Fe_{0.85}Ni_{0.05}O_{3-δ} [X. Wu, J. Yu, G. Yang, H. Liu, W. Zhou, Z. Shao, Perovskite oxide/carbon nanotube hybrid bifunctional electrocatalysts for overall water splitting, Electrochim Acta. 286 (2018) 47-54], Rh-loaded SrTiO₃ [H. J. Yoon, S. K. Kim, W. Huang, Y. Sohn, Comparable electrocatalytic performances of carbon- and Rh-loaded SrTiO₃ nanoparticles, Chinese Chemical Letters. 29 (2018) 800-804], and Eu-doped SrTiO₃ [H. J. Jang, S. J. Park, J. H. Yang, S.-M. Hong, C. K. Rhee, D. Kim, Y. Sohn, Photocatalytic and photoelectrocatalytic properties of Eu(III)-doped perovskite SrTiO₃ nanoparticles with dopant level approaches, Mater Sci Semicond Process. 132 (2021) 105919]. However, the production of these materials often involves harsh conditions such as high temperature and high pressure, resulting in the formation of by-products.

Although a few perovskite materials have been studied in the past, a need still exists to provide an electrode with improved EHER. In view of the forgoing, one objective of the present disclosure is to provide a perovskite material-based electrode for water-splitting applications. A further objective of the present disclosure is to describe a method of making the perovskite material-based electrode including a pulsed laser ablation in liquid (PLAL) step.

### SUMMARY

In an exemplary embodiment, an electrode is described. The electrode includes a transparent substrate. The electrode further includes a layer of a perovskite-based nanocomposite (PTNC) material at least partially covering a surface of the transparent substrate. In some embodiments, the PTNC material includes gold (Au) nanoparticles, graphitic carbon nitride (g-C₃N₄) nanoparticles, and perovskite-based nanoparticles.

In some embodiments, the transparent substrate is a glass substrate. In some embodiments, the glass substrate is at least one selected from the group consisting of a fluorine doped tin oxide (FTO) glass substrate, a tin doped indium oxide (ITO) glass substrate, an aluminum doped zinc oxide (AZO) glass substrate, a niobium doped titanium dioxide (NTO) glass substrate, an indium doped cadmium oxide (ICO) glass substrate, an indium doped zinc oxide (IZO) glass substrate, a fluorine doped zinc oxide (FZO) glass substrate, a gallium doped zinc oxide (GZO) glass substrate, an antimony doped tin oxide (ATO) glass substrate, a phosphorus doped tin oxide (PTO) glass substrate, a zinc antimonate glass substrate, a zinc oxide glass substrate, a ruthenium oxide glass substrate, a rhenium oxide glass substrate, a silver oxide glass substrate, and a nickel oxide glass substrate.

In some embodiments, the transparent substrate is a FTO glass substrate.

In some embodiments, the Au nanoparticles present in the PTNC material are spherical nanoparticles having an average diameter of 5 to 50 nanometers (nm), and an interplanar spacing d(111) of the (111) plane in a range of 0.15 to 0.3 nm as determined by X-ray diffraction.

In some embodiments, the g-C₃N₄ nanoparticles present in the PTNC material are nanosheets having an average thickness of 1 to 20 nm, and an interplanar spacing d(002) of the (002) plane in a range of 0.25 to 0.35 nm as determined by X-ray diffraction.

In some embodiments, the perovskite-based nanoparticles present in the PTNC material are spherical nanoparticles having an average diameter of 50 to 200 nm, and an interplanar spacing d(100) of the (100) plane in a range of 0.35 to 0.45 nm as determined by X-ray diffraction.

In some embodiments, the PTNC material includes 20 to 40 wt. % carbon, 10 to 30 wt. % strontium, 10 to 30 wt. % titanium, 10 to 30 wt. % zirconium, 10 to 30 wt. % barium, 10 to 30 wt. % niobium, 10 to 30 wt. % lanthanum, 10 to 30 wt. % manganese, 10 to 30 wt. % aluminum, 10 to 20 wt. % oxygen, 10 to 20 wt. % gold, and 5 to 15 wt. % nitrogen, each wt. % based on a total weight of the PTNC material by energy dispersive X-ray (EDX).

In some embodiments, the electrode has a current density of 150 to 250 milliamperes per square centimeter (mA/cm²) in an acidic medium at a scan rate of 5 to 20 millivolts per second (mV/s).

In some embodiments, the electrode has an overpotential of 0.1 to 0.3 volts (V) in an acidic medium at a scan rate of 5 to 20 mV/s.

In some embodiments, the electrode has a Tafel slope of 40 to 80 millivolts per decade (mV/decade) in an acidic medium at a scan rate of 5 to 20 mV/s.

In some embodiment, a method of making the electrode includes preparing the PTNC material by following steps. The method includes grinding and mixing urea and melamine to form a first mixture. The method includes calcining the first mixture at a temperature of at least 550° C. to form the g-C₃N₄. The method further includes mixing and dispersing particles of the g-C₃N₄, an auric salt, and a perovskite-based material in water to form a second mixture. The method further includes sonicating and homogenizing the second mixture to form a resultant mixture. The method further includes irradiating the resultant mixture with a pulsed laser beam at a wavelength of 520 to 540 nm and a pulse duration of 8 nanoseconds (ns) under continuous agitation to form a third mixture. The method further includes heating the third mixture at a temperature of at least 90° C. to form the PTNC material.

In some embodiments, a weight ratio of the urea and melamine is in a range of 1:10 to 10:1.

In some embodiments, the auric salt includes at least one of auric chloride, auric sodium chloride, potassium auric cyanide, and its hydrate.

In some embodiments, the perovskite-based material includes at least one of SrTiO₃, SrZrO₃, BaTiO₃, BaSrTiO₃, SrNbTiO₃, BaCaTiO₃, LaMnO₃ and LaAlO₃.

In some embodiments, the method further includes coating the transparent substrate by mixing the PTNC material, a sulfonated polymer and a solvent mixture to form a fourth mixture;

sonicating the fourth mixture to form a coating composition; and further drop casting the coating composition onto a surface of the transparent substrate and drying to form the electrode having the layer of the PTNC material at least partially covered on the surface of the transparent substrate.

In some embodiments, the sulfonated polymer includes at least one of Nafion, sulfonated poly(ether ether ketone) (SPEEK), sulfonated polyimide, sulfonated poly(phenylene oxide) (PPO), sulfonated poly(arylene ether sulfone), and sulfonated poly(4-phenoxybenzoyl-1,4-phenylene).

In some embodiments, the solvent mixture includes at least one organic solvent selected from the group consisting of a ketone solvent, an ester solvent, an alcohol solvent, an amide solvent, and an ether solvent.

In some embodiments, the solvent mixture includes an alcohol solvent and water. In some embodiments, a volume ratio of the alcohol solvent and water is in a range of 1:1 to 1:10.

In another exemplary embodiment, a method for electrochemical water splitting is described. The method includes applying a potential between an anode and a cathode in an electrochemical cell containing an electrolyte to form hydrogen and oxygen. In some embodiments, the cathode includes the electrode. In some embodiments, the electrolyte including an aqueous solution of an acid at a concentration of 0.001 to 3 molars (M).

In some embodiments, the acid includes at least one of sulfuric acid, nitric acid, phosphoric acid, boric acid, and citric acid.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow chart of a method of making an electrode including a PTNC material on a transparent substrate, according to certain embodiments;

FIG. 2 is a schematic flow chart of a method coating the transparent substrate of the electrode, according to certain embodiments;

FIG. 3 is an exemplary schematic diagram of pulsed laser ablation in liquid (PLAL) method, according to certain embodiments;

FIG. 4 depicts X-ray diffraction (XRD) profiles of g-C₃N₄, SrTiO₃, SrTiO₃/g-C₃N₄, and Au@SrTiO₃/g-C₃N₄, according to certain embodiments;

FIG. 5A depicts zoomed XRD profile of the Au@SrTiO₃/g-C₃N₄ of FIG. 4, according to certain embodiments;

FIG. 5B depicts zoomed XRD profile of the Au@SrTiO₃/g-C₃N₄ and the SrTiO₃/g-C₃N₄ of FIG. 4, according to certain embodiments;

FIG. 6A is a scanning electron microscope (SEM) image of the g-C₃N₄, according to certain embodiments;

FIG. 6B is a SEM image of the SrTiO₃, according to certain embodiments;

FIG. 6C is a SEM image of Au nanoparticles, according to certain embodiments;

FIG. 6D is a SEM image of the Au@SrTiO₃/g-C₃N₄, according to certain embodiments;

FIG. 7A depicts a transmission electron microscopy (TEM) image of the Au@SrTiO₃/g-C₃N₄, according to certain embodiments;

FIG. 7B depicts a high-resolution transmission electron microscopy (HR-TEM) image of the Au@SrTiO₃/g-C₃N₄, according to certain embodiments;

FIG. 8A depicts an energy dispersive X-ray (EDX) spectrum of the Au@SrTiO₃/g-C₃N₄, according to certain embodiments;

FIG. 8B depicts elemental analysis maps of the Au@SrTiO₃/g-C₃N₄, according to certain embodiments;

FIG. 9A-F depict X-ray photoelectron spectroscopy (XPS) spectra of the Au@SrTiO₃/g-C₃N₄, according to certain embodiments;

FIG. 9A depicts an XPS spectrum of C 1s of the Au@SrTiO₃/g-C₃N₄, according to certain embodiments;

FIG. 9B depicts an XPS spectrum of N 1s of the Au@SrTiO₃/g-C₃N₄, according to certain embodiments;

FIG. 9C depicts an XPS spectrum of Au 4f of the Au@SrTiO₃/g-C₃N₄, according to certain embodiments;

FIG. 9D depicts an XPS spectrum of Sr 3d of the Au@SrTiO₃/g-C₃N₄, according to certain embodiments;

FIG. 9E depicts an XPS spectrum of Ti 2p of the Au@SrTiO₃/g-C₃N₄, according to certain embodiments;

FIG. 9F depicts an XPS spectrum of O 1s of the Au@SrTiO₃/g-C₃N₄, according to certain embodiments;

FIG. 10 depicts XPS survey scan analysis of the Au@SrTiO₃/g-C₃N₄, according to certain embodiments;

FIG. 11 depicts linear sweep voltammetry (LSV) polarization curves of the SrTiO₃/g-C₃N₄ with different wt. % of the g-C₃N₄; the Au@SrTiO₃/g-C₃N₄ with different molar concentrations of Au hybrid hydrogen evolution reaction (HER) electrocatalysts measured in acidic medium (0.5 molars (M), H₂SO₄) at a scan rate of 10 millivolts per second (mV/s), according to certain embodiments;

FIG. 12A depicts LSV plots for various electrodes, according to certain embodiments;

FIG. 12B depicts current density, overpotential, and onset potential histogram for the various electrodes, according to certain embodiments;

FIG. 12C depicts cyclic voltammograms of the Au@SrTiO₃/g-C₃N₄ at various scan rates, according to certain embodiments;

FIG. 12D depicts an electrochemical surface area (ECSA) for the various electrodes, according to certain embodiments;

FIG. 12E depicts double-layer capacitance (DLC) and ECSA histogram for the various electrodes, according to certain embodiments;

FIG. 12F depicts Nyquist plots for the various electrodes at an over-potential of 0.227 volts (V), according to certain embodiments;

FIG. 13A depicts Tafel plots of the various electrodes, according to certain embodiments;

FIG. 13B depicts LSV curves of the Au@SrTiO₃/g-C₃N₄ before and after 1000 successive scans, according to certain embodiments;

FIG. 13C depicts overpotential of the Au@SrTiO₃/g-C₃N₄ before and after 1000 successive scans, according to certain embodiments;

FIG. 13D depicts chronopotentiometry curve of the Au@SrTiO₃/g-C₃N₄ at current density of −100 mA/cm², according to certain embodiments;

FIG. 13E depicts a SEM image of the Au@SrTiO₃/g-C₃N₄ after stability test, according to certain embodiments;

FIG. 13F depicts an XRD pattern of the Au@SrTiO₃/g-C₃N₄ after stability test, according to certain embodiments; and

FIG. 14 is an exemplary schematic diagram depicting HER mechanism with the PTNC electrode when operated in an acidic medium, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

Aspects of the present invention are directed toward an electrode including a layer of perovskite-based nanocomposite (PTNC) material on a transparent substrate for electrocatalytic hydrogen evolution reaction (EHER). As used herein, the term ‘EHER’ refers to the electrochemical reaction which involves the reduction of protons for hydrogen production. The electrochemical reaction requires highly efficient and robust catalysts to lower the overpotential and energy consumption.

According to an aspect of the present disclosure, an electrode is described. The electrode includes a transparent substrate. In some embodiments, the transparent substrate is a glass substrate. In some further embodiments, the glass substrate is at least one selected from the group consisting of a fluorine doped tin oxide (FTO) glass substrate, a tin doped indium oxide (ITO) glass substrate, an aluminum doped zinc oxide (AZO) glass substrate, a niobium doped titanium dioxide (NTO) glass substrate, an indium doped cadmium oxide (ICO) glass substrate, an indium doped zinc oxide (IZO) glass substrate, a fluorine doped zinc oxide (FZO) glass substrate, a gallium doped zinc oxide (GZO) glass substrate, an antimony doped tin oxide (ATO) glass substrate, a phosphorus doped tin oxide (PTO) glass substrate, a zinc antimonate glass substrate, a zinc oxide glass substrate, a ruthenium oxide glass substrate, a rhenium oxide glass substrate, a silver oxide glass substrate, and a nickel oxide glass substrate. In a preferred embodiment, the glass substrate is a FTO glass substrate. Optionally, the glass substrate may be replaced by a titanium plate or a copper plate.

In an embodiment, the substrate may have a thickness in a range of about 1.6 millimeters (mm) to 3.2 mm, for example, ranging from about 1.8 mm to about 3.0 mm, from about 2.0 mm to about 2.8 mm, including all ranges and subranges therebetween.

The electrode further includes a layer of a PTNC material at least partially covering the surface of the transparent substrate. In some embodiments, at least 50% of the surface of the transparent substrate is covered by the PTNC material based on a total surface area of the transparent substrate, preferably at least 70%, preferably at least 90%, or even more preferably at least 99%, based on the total surface area of the transparent substrate. In another embodiment only one side of the transparent substrate is covered with the PTNC material. Other ranges are also possible.

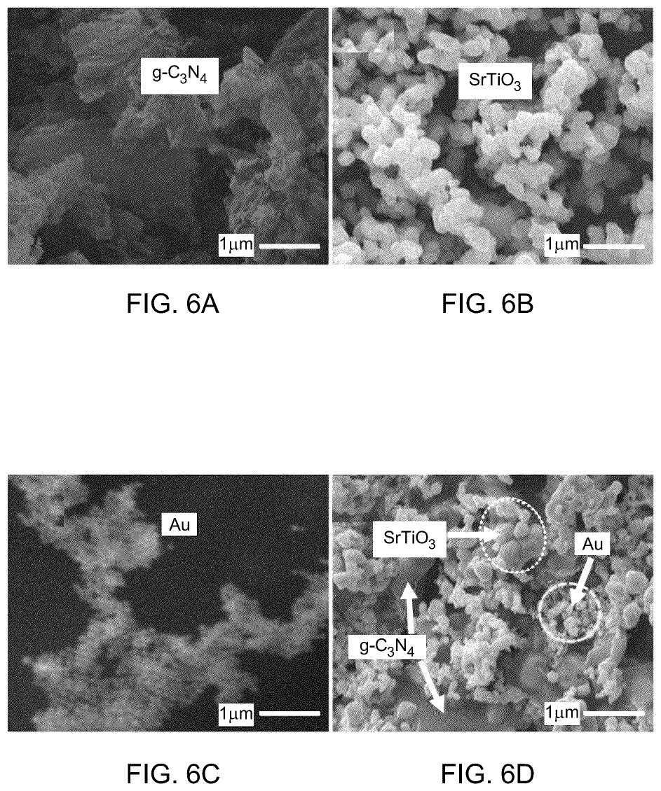

In some embodiments, the PTNC material includes gold (Au) nanoparticles. FIG. 6C illustrate a SEM image of Au nanoparticles. The Au nanoparticles present in the PTNC material preferably have a substantially spherical shape. The spherical shape Au nanoparticles possess minimum surface area and assure a minimum possible state of energy. The geometry of the Au nanoparticles may alternately include, but is not limited to, a circular, polygonal, triangular, and rectangular shape. The Au nanoparticles have an average diameter of 5 to 50 nanometers (nm), more preferably 10 to 40 nm and yet more preferably 20 to 30 nm. In some further embodiments, the Au nanoparticles have an interplanar spacing d(111) of the (111) plane in a range of 0.15 to 0.3 nm as determined by X-ray diffraction, more preferably 0.20 to 0.28 nm, more preferably 0.23 to 0.25 nm, and yet more preferably 0.232 nm, as determined by X-ray diffraction. Other ranges are also possible. As used herein, the term ‘d-spacing’ refers to the distance between successive, parallel planes of atoms.

In some embodiments, the PTNC material further includes graphitic carbon nitride (g-C₃N₄) nanoparticles. FIG. 6A illustrates a SEM image of the g-C₃N₄. The g-C₃N₄ nanoparticles present in the PTNC material are nanosheets having an average thickness of 1 to 20 nm, more preferably 5 to 18 nm, and yet more preferably, 10 to 15 nm. In some further embodiments, the g-C₃N₄ nanoparticles have an interplanar spacing d(002) of the (002) plane in a range of 0.25 to 0.35 nm as determined by X-ray diffraction, more preferably 0.28 to 0.33 nm, more preferably 0.30 to 0.32 nm, and yet more preferably 0.328. Other ranges are also possible.

In some embodiments, the PTNC material further includes perovskite-based nanoparticles. FIG. 6B illustrates a SEM image of the perovskite-based nanoparticles. The perovskite-based nanoparticles present in the PTNC material are spherical nanoparticles having an average diameter of 50 to 200 nm, more preferably 80 to 180 nm, and yet more preferably 100 to 150 nm. In some further embodiments, the perovskite-based nanoparticles have an interplanar spacing d(100) of the (100) plane in a range of 0.35 to 0.45 nm as determined by X-ray diffraction, more preferably 0.36 to 0.39 nm, and yet more preferably 0.385 nm. Other ranges are also possible. In some preferred embodiments, the perovskite-based material includes at least one of SrTiO₃, SrZrO₃, BaTiO₃, BaSrTiO₃, SrNbTiO₃, BaCaTiO₃, LaMnO₃, and LaAlO₃.

The PTNC material includes 20 to 40 wt. %, more preferably 25 to 38 wt. %, more preferably 28 to 35 wt. %, and yet more preferably 30 wt. % carbon; 10 to 30 wt. %, more preferably 15 to 25 wt. %, more preferably 19 to 21 wt. %, and yet more preferably 20.6 wt. % strontium; 10 to 30 wt. %, more preferably 11 to 15 wt. %, more preferably 12.5 to 14.5 wt. %, and yet more preferably 13.9 wt. % titanium; 10 to 30 wt. %, more preferably 15 to 25 wt. %, and yet more preferably 20 to 23 wt. % zirconium; 10 to 30 wt. %, more preferably 15 to 25 wt. %, and yet more preferably 20 to 23 wt. % barium; 10 to 30 wt. %, more preferably 15 to 25 wt. %, and yet more preferably 20 to 23 wt. % niobium; 10 to 30 wt. %, more preferably 15 to 25 wt. %, and yet more preferably 20 to 23 wt. % lanthanum; 10 to 30 wt. %, more preferably 15 to 25 wt. %, and yet more preferably 20 to 23 wt. % manganese; 10 to 30 wt. %, more preferably 15 to 25 wt. %, and yet more preferably 20 to 23 wt. % aluminum; 10 to 20 wt. %, more preferably 11 to 18 wt. %, more preferably 12 to 14 wt. %, and yet more preferably 13 wt. % oxygen; 10 to 20 wt. %, more preferably 12 to 15 wt. %, preferably 12 to 13 wt. %, and yet more preferably 12.7 wt. % gold; and 5 to 15 wt. %, more preferably 8 to 13 wt. %, more preferably 9 to 10 wt. %, and yet more preferably 9.9 wt. % nitrogen; each wt. % based on the total weight of the PTNC material by energy dispersive X-ray (EDX). Other ranges are also possible.

In an embodiment, the surface of the substrate is deposited partially or wholly with at least one layer of the PTNC material in a uniform and continuous manner. In a preferred embodiment, the PTNC material forms a continuous layer on at least one surface of the FTO glass substrate. In an embodiment, particles of the PTNC material may form a monolayer on the FTO glass substrate. In another embodiment, the particles of the PTNC material may form more than a single layer on the FTO glass substrate.

In a preferred embodiment, the perovskite-based nanoparticles may be SrTiO₃. The PTNC material may contain Au, SrTiO₃, g-C₃N₄. In some preferred embodiments, the PTNC material is prepared with various percentages of g-C₃N₄ and Au for decoration on SrTiO₃ to form Au@SrTiO₃/g-C₃N₄-decorated PTNCs-based electrodes. The synthesized electrodes were evaluated for the EHER that operated in an acidic media consisting of 0.5 molar (M) H₂SO₄. In one embodiment, the synthesized PTNCs demonstrated an improved EHER at a low over-potential of 0.1 to 0.3 volts (V), or preferably about 0.227 V. In addition, the obtained highest cathodic current density (−202.96 milliamperes per square centimeter (mA/cm²)) is about 9.91, about 7.41, about 4.08, about 2.85, and about 1.48 times higher than that of bare g-C₃N₄, SrTiO₃, Au@g-C₃N₄, Au@SrTiO₃, and SrTiO₃/g-C₃N₄ respectively, indicating improved performance of the prepared PTNCs. The Tafel slope of 40 to 80 millivolts per decade (mV/decade), or preferably about 62.36 mV/decade, confirmed the presence of the Volmer-Heyrovsky mechanism to support the enhanced EHER cycle of the PTNCs. The improved intrinsic electrocatalytic kinetic performance of the PTNCs can be ascribed to the reduced charge transfer resistance, increased electrochemical surface area, availability of several active sites, and synergistic interaction between Au, SrTiO₃, and g-C₃N₄. As used herein, the term ‘synergistic interaction’ refers to an interaction or cooperation between two or more components that produces a combined effect greater than the sum of their respective effects.

The crystalline structures of g-C₃N₄, SrTiO₃, SrTiO₃/g-C₃N₄ and Au@SrTiO₃/g-C₃N₄ may be characterized by X-ray diffraction (XRD), respectively. In some embodiments, the XRD patterns are collected in a Rigaku diffractometer equipped with a Cu-Kα radiation source (λ-0.1541 nm) for a 20 range extending between 5 and 80°, preferably 15 and 70°, further preferably 30 and 60° at an angular rate of 0.005 to 0.04° s⁻¹, preferably 0.01 to 0.03° s⁻¹, or even preferably 0.02° s⁻¹.

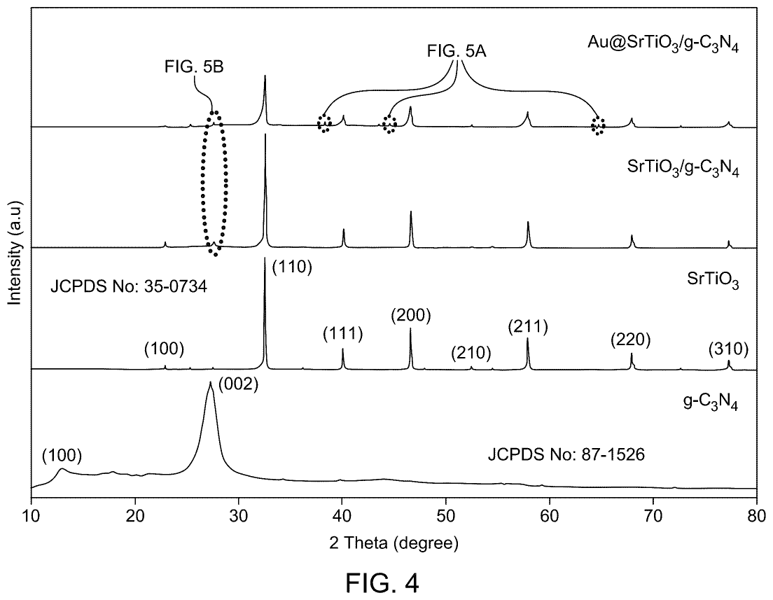

In some embodiments, the g-C₃N₄ has at least one intense peak with a 2 theta (0) value in a range of 22 to 32° in an X-ray diffraction (XRD) spectrum, or preferably about 27°, as depicted in FIG. 4. In some further embodiments, the SrTiO₃ has at least a first intense peak with a 2θ value in a range of 17 to 27° in the XRD spectrum, at least a second intense peak with a 2θ value in a range of 27 to 37°, at least a third intense peak with a 2θ value in a range of 37 to 43°, at least a fourth intense peak with a 2θ value in a range of 43 to 49°, at least a fifth intense peak with a 20 value in a range of 49 to 55°, at least a sixth intense peak with a 2θ value in a range of 55 to 61°, at least a seventh intense peak with a 2θ value in a range of 65 to 71°, at least an eighth intense peak with a 2θ value in a range of 75 to 81° in the XRD spectrum, as depicted in FIG. 4. In some further preferred embodiments, the Au@SrTiO₃/g-C₃N₄ has at least a first peak with a 2θ value in a range of 33 to 41° in the XRD spectrum, at least a second peak with a 2θ value in a range of 41 to 49°, at least a third intense peak with a 2θ value in a range of 60 to 70° in the XRD spectrum, as depicted in FIG. 4. Other ranges are also possible.

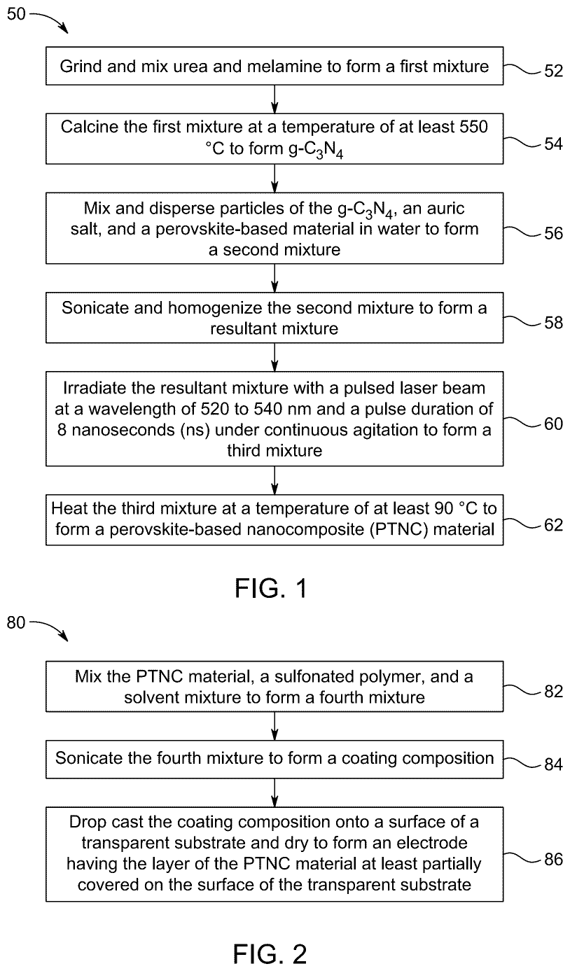

FIG. 1 illustrates a schematic flow chart of a method 50 of preparing the PTNC material for the fabrication of the electrode. The order in which the method 50 described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes grinding and mixing urea and melamine to form a first mixture. The urea and melamine are ground together to reduce their particle size to a micrometer/nanometer scale. The grinding is carried out for about 25 to 35 minutes, more preferably 28 to 32 minutes, and yet more preferably 30 minutes, to obtain the first mixture. In an embodiment, the weight ratio of urea and melamine is in a range of 1:10 to 10:1, preferably 1:5 to 5:1, preferably 1:1 to 3:1, and more preferably 1:1. The grinding may be carried out using any suitable means, for example, ball milling, blending, etc., using manual methods (e.g., mortar) or machine-assisted methods such as using a mechanical blender, or any other apparatus known to those of ordinary skill in the art. Other ranges are also possible.

At step 54, the method 50 includes calcining the first mixture at a temperature of at least 550° C. to form the g-C₃N₄. The calcination is carried out by heating it to a high temperature, under a restricted supply of ambient oxygen. This is performed to remove impurities or volatile substances and to incur thermal decomposition. Typically, the calcination is carried out in a furnace preferably equipped with a temperature control system, which may provide a heating rate of up to 50° C./min, preferably up to 40° C./min, preferably up to 30° C./min, preferably up to 20° C./min, preferably up to 10° C./min, preferably up to 5° C./min. In preferred embodiments, the first mixture is heated with a heating rate in the range of 4 to 8° C./min, preferably 4.5 to 7.5° C./min, preferably 5° C./min to a temperature range of 500 to 600° C., preferably 520 to 580° C., preferably 550° C. for 3 to 5 hours, more preferably 3.5 to 4.5 hours, and yet more preferably 4 hours. Other ranges are also possible.

At step 56, the method 50 includes mixing and dispersing particles of the g-C₃N₄, an auric salt, and a perovskite-based material in water to form a second mixture. The auric salt includes at least one of auric chloride, auric sodium chloride, potassium auric cyanide, and its hydrate. In a preferred embodiment, the auric salt is auric chloride. The molar concentration of the auric salt is in a range of 0.0001 to 0.001M, preferably 0.00.003 to 0.0007, more preferably about 0.0005M.

Other ranges are also possible. Further, the perovskite-based material includes at least one of SrTiO₃, SrZrO₃, BaTiO₃, BaSrTiO₃, SrNbTiO₃, BaCaTiO₃, LaMnO₃, and LaAlO₃. In some embodiments, the perovskite-based material may include, but is not limited to, calcium titanate, lead titanate, bismuth ferrite, lanthanum ytterbium oxide, silicate perovskite, lanthanum manganite, yttrium aluminum perovskite (YAP). In a preferred embodiment, the perovskite-based material includes SrTiO₃. In some embodiments, the g-C₃N₄ is present in the second mixture at a concentration of 0.05 to 0.3 milligrams per milliliter (mg/mL), preferably 0.07 to 0.25 mg/mL, preferably 0.1 to 0.2 mg/mL, or even more preferably about 0.12 mg/mL. In some preferred embodiments, the perovskite-based material is present in the second mixture at a concentration of 1 to 10 milligrams per milliliter (mg/mL), preferably 2 to 8 mg/mL, preferably 3 to 6 mg/mL, or even more preferably about 4 mg/mL. Other ranges area also possible.

At step 58, the method 50 includes sonicating and homogenizing the second mixture to form a resultant mixture. The sonicating and homogenization can be performed ultrasonically for a time range of 25 to 35 minutes, more preferably 27 to 32 minutes, and yet more preferably 30 minutes. Other ranges are also possible. As used herein, the term ‘sonication’ refers to the process in which sound waves are used to agitate particles in a solution. In some embodiments, other modes of agitation known to those of ordinary skill in the art, for example, via stirring, swirling, mixing, or a combination thereof may be employed to form the resultant mixture.

At step 60, the method 50 includes irradiating the resultant mixture with a pulsed laser beam at a wavelength of 520 to 540 nm, more preferably 528 to 536 nm, and yet more preferably 532 nm and a pulse duration of 2 to 14 nanoseconds (ns), preferably 6 to 10 ns, or even more preferably about 8 ns, under continuous agitation for about 15 to 25 minutes, more preferably 18 to 22 minutes, and yet more preferably 20 minutes to form a third mixture. The frequency of the pulsed laser beam is in a range of 8-15 hertz (Hz), preferably about 10 Hz. The energy of the pulsed laser is in a range of 200 to 500 millijoules (mJ), preferably 250 to 450 mJ, preferably 300 to 400 mJ, or even more preferably about 350 mJ. The width of the pulsed laser is in a range of 2 to 15 ns, preferably 6 to 11 ns, or even more preferably about 9 ns. Other ranges are also possible.

At step 62, the method 50 includes heating the third mixture at a temperature of at least 90° C. to form the PTNC material. The heating can be performed for 3.5 to 4.5 hours, more preferably 4 hours. The heating can be performed in an oven, a microwave, and an autoclave. Other ranges are also possible.

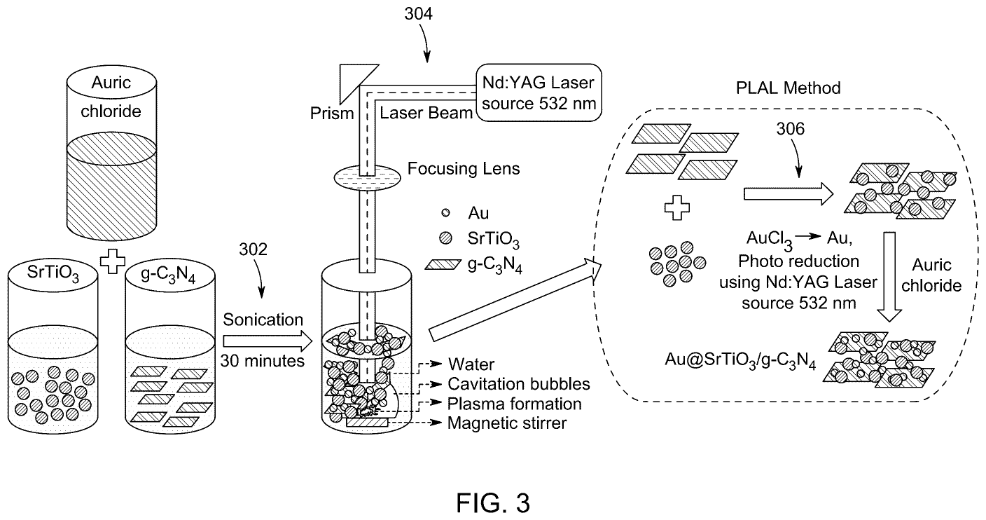

FIG. 3 is a schematic diagram of pulsed laser ablation in liquid (PLAL) method. In some embodiment, particles of the g-C₃N₄, AuCl₃, and SrTiO₃ are sonicated for about 30 minutes to form a mixture 302. In some embodiments, a pulsed laser is used to ablate the mixture 302 of auric chloride, SrTiO₃, and g-C₃N₄ after sonicating. In some further embodiments, the pulsed laser is operated at a wavelength of about 532 nm, a pulse energy of about 350 millijoules (mJ), a pulse duration of 8 ns, a pulse width of 9 ns, and repetition rate of 10 Hz. In some embodiments, the laser pulses are firstly immersed in de-ionized water (DIW) and then collimated on the mixture 302 for about 20 minutes. A plasma plume may be generated through the initiation of AuCl₃ reduction in the mixture 302 followed by the anchoring of Au nanoparticles onto SrTiO₃/g-C₃N₄ surfaces (306). In some preferred embodiments, a cavitation bubble is expanded and erupted to create dispersed Au@SrTiO₃/g-C₃N₄ nanoparticles in the mixture 302.

FIG. 2 illustrates a schematic flow chart of a method 80 of coating the transparent substrate. The order in which the method 80 described is not intended to be construed as a limitation, and any number of the described method steps can be combined in any order to implement the method 80. Additionally, individual steps may be removed or skipped from the method 80 without departing from the spirit and scope of the present disclosure.

At step 82, the method 80 includes mixing the PTNC material, a sulfonated polymer, and a solvent mixture to form a fourth mixture. In some embodiments, the sulfonated polymer includes at least one of Nafion, sulfonated poly(ether ether ketone) (SPEEK), sulfonated polyimide, sulfonated poly(phenylene oxide) (PPO), sulfonated poly(arylene ether sulfone), and sulfonated poly(4-phenoxybenzoyl-1,4-phenylene). In a preferred embodiment, the sulfonated polymer is Nafion. In some further embodiments, the solvent mixture includes at least one organic solvent selected from the group consisting of a ketone solvent (such as methyl ethyl ketone (MEK), methyl isobutyl ketone (MIBK), mesityl oxide (MO), and isophorone), an ester solvent (such as benzyl benzoate, bis(2-ethylhexyl) adipate, bis(2-ethylhexyl) phthalate, 2-butoxyethanol acetate, and butyl acetate), an alcohol solvent (such as ethanol, toluene, and saponins), an amide solvent (such as dimethylformamide) and an ether solvent (such as ethoxyethane (diethyl ether), methoxyethane (methyl ethyl ether), 2-methoxy-2-methylpropane (MTBE), and phenoxybenzene (diphenyl ether). The solvent mixture includes an alcohol solvent and water. A volume ratio of the alcohol solvent and water is in a range of 1:1 to 1:10. Other ranges are also possible.

At step 84, the method 80 includes sonicating the fourth mixture to form a coating composition. The fourth mixture can be ultrasonicated for 18 to 22 minutes, more preferably 20 minutes to get the coating composition. Other ranges are also possible.

At step 86, the method 80 includes drop casting the coating composition onto a surface of the transparent substrate and drying to form the electrode having the layer of the PTNC material at least partially covered on the surface of the transparent substrate. The drying to form the electrode can be done in a range of 63 to 67° C., more preferably 65° C. for about 1.5 to 2.5 hours, more preferably 2 hours. Other ranges are also possible.

A method for electrochemical water splitting is described. The electrochemical water splitting may be performed in a Teflon-made 3-electrode electrochemical cell equipped with a Potentiostat (AutoLab PGSTAT302N) for evaluating the performance of the electrode. In some embodiments, the cell may also include an Ag/AgCl (KCl solution of 3.0 M) reference electrode, a Pt counter electrode, and a working electrode. In some embodiments, the working electrode may be a glassy carbon (GC), and a PTNC coated glassy carbon prepared according to the method 80. In some further embodiment, the PTNC material may be dispersed in an electrolyte as a catalyst for water splitting. In some preferred embodiments, a linear sweep voltammetry test may be performed at a scan rate of 10 mV/s. In some further preferred embodiments, the electrochemical impedance spectroscopy (EIS) measurement may be performed at AC voltage of 10 mV and frequency in the range of 0.1 to 105 Hz.

The method for electrochemical water splitting further includes applying a potential between an anode and a cathode in an electrochemical cell containing an electrolyte to form hydrogen and oxygen. The cathode includes the electrode as described above. The electrolyte includes an aqueous solution of an acid at a concentration of 0.001 to 3 M, preferably 0.01 to 2.5 M, preferably 0.1 to 2 M, preferably 0.2 to 1.5 M, preferably 0.4 to 1 M, and yet more preferably about 0.5 M. The acid includes at least one of sulfuric acid, nitric acid, phosphoric acid, boric acid, and citric acid.

The electrode of the present disclosure preferably has a current density of 150 to 250 mA/cm², more preferably 200 to 230 mA/cm², and yet more preferably 210 to 220 mA/cm² in an acidic medium at a scan rate of 5 to 20 millivolts per second (mV/s), more preferably 10 to 18 mV/s, and yet more preferably 12 to 16 mV/s. Other ranges are also possible. As used herein, the term ‘current density’ refers to the amount of current traveling per unit cross-section area. The electrode further has an overpotential of 0.1 to 0.3 V, more preferably 0.15 to 0.28, and yet more preferably 0.2 to 0.25 V in an acidic medium at a scan rate of 5 to 20 mV/s, more preferably 10 to 18 mV/s, and yet more preferably 12 to 16 mV/s. Other ranges are also possible. As used herein, the term ‘overpotential’ is referred to as the difference between the equilibrium potential for a given reaction (also called the thermodynamic potential) and the potential at which a catalyst operates at a specific current under specific conditions. The electrode further has a Tafel slope of 40 to 80 millivolts per decade (mV/decade), more preferably 50 to 70 mV/decade, and yet more preferably 60 to 65 mV/decade in an acidic medium at a scan rate of 5 to 20 mV/s, more preferably 10 to 18 mV/s, and yet more preferably 12 to 16 mV/s. Other ranges are also possible.

### EXAMPLES

The following examples describe and demonstrate exemplary embodiments of the electrode described herein. The examples are provided solely for the purpose of illustration and are not to be construed as limitations of the present disclosure, as many variations thereof are possible without departing from the spirit and scope of the present disclosure.

### Example 1: Preparation of g-C₃N₄

1.0 gram (g) of urea and 1.0 g of melamine were ground together for about 30 minutes to form a mixture. Then, the mixture was put into a silica crucible with a lid and calcined for 4 hours (at 550° C.) at a heating rate of 5° C./min, then cooling to room temperature. Finally, a yellow color powder of g-C₃N₄ was achieved.

### Example 2: Synthesis of SrTiO₃/g-C₃N₄

Composites of SrTiO₃/g-C₃N₄ (x), where x=0, 1, 2, 3, and 4 wt. % were prepared using the PLAL method [A. Ilyas, M. A. Gondal, Z. H. Yamani, U. Baig, Facile synthesis of titanium dioxide-cadmium sulfide nanocomposite using pulsed laser ablation in liquid and its performance in photovoltaic and photocatalytic applications, Int J Energy Res. 41 (2017) 1422-1435; M. Hassan, M. A. Gondal, E. Cevik, M. A. Dastageer, U. Baig, R. A. Moqbel, T. F. Qahtan, A. Bozkurt, N. al Abass, Laser assisted anchoring of cadmium sulfide nanospheres into tungsten oxide nanosheets for enhanced photocatalytic and electrochemical energy storage applications, Colloids Surf A Physicochem Eng Asp. 617 (2021) 126318; and M. I. Chebanenko, N. v Zakharova, A. A. Lobinsky, V. I. Popkov, Ultrasonic-Assisted Exfoliation of Graphitic Carbon Nitride and its Electrocatalytic Performance in Process of Ethanol Reforming, Semiconductors. 53 (2019) 2072-2077, each incorporated herein by reference in their entirety]. First, SrTiO₃/g-C₃N₄-(1%) was made by combining g-C₃N₄ (10 mg) and SrTiO₃ (100 mg) in deionized water, DIW (25 mL). Then, the mix was ultrasonically homogenized for 30 minutes. The resultant mix was irradiated with a Q-Switched Nd-YAG pulsed laser (wavelength of 532 nm with 8 nanoseconds (ns) of pulse duration). All other mixes were prepared using the same protocol. Each sample was ablated using a laser for 20 minutes with continuous stirring at an increasing laser intensity. The resultant g-C₃N₄ was incorporated in SrTiO₃ nanoparticles suspension followed by drying at 90° C. for 4 hours. The same procedure was used to make each SrTiO₃/g-C₃N₄ sample at different g-C₃N₄ content. The synthesized samples were coded as g-C₃N₄, SrTiO₃, SrTiO₃/g-C₃N₄-(1%), SrTiO₃/g-C₃N₄-(2%), SrTiO₃/g-C₃N₄-(3%), and SrTiO₃/g-C₃N₄-(4%).

### Example 3: Preparation of Au@SrTiO₃/g-C₃N₄

The PLAL method was used to synthesize the Au(y)@SrTiO₃/g-C₃N₄ (y=0.0005, 0.001, and 0.002 M) PTNCs. Au(0.0005M)@SrTiO₃/g-C₃N₄-3% was synthesized by combining Auric chloride (0.0005 M), g-C₃N₄ (30 mg), and SrTiO₃ (100 mg) in DIW (25 mL) and ultrasonically homogenizing the mixture for 30 minutes. The resultant mixture (Au+SrTiO₃+g-C₃N₄) was ablated via the same laser as before. Each sample was exposed to a laser pulse (wavelength of 532 nm with 8 ns of pulse duration) for 20 minutes with continuous stirring and increasing intensity. The resultant Au was incorporated in SrTiO₃ and g-C₃N₄ nanoparticles suspension followed by drying at 90° C. for 4 hours. An identical procedure was followed to prepare each Au@SrTiO₃/gC₃N₄ sample at different Au content. The prepared PTNCs were named as Au(0.0005M)@SrTiO₃/g-C₃N₄-3%, Au(0.001M)@SrTiO₃/g-C₃N₄-3%, and Au(0.002M)@SrTiO₃/g-C₃N₄-3%.

### Example 4: Electrochemical Measurements

A teflon-made 3-electrode electrochemical cell with a potentiostat (AutoLab PGSTAT302N) was used to evaluate the feasibility of the EHER electrode of the as-prepared PTNCs. The cell used Ag/AgCl (KCl solution of 3.0 M) as a reference, Pt as a counter, and glassy carbon (GC) as a working electrode. As used herein, the term ‘working electrode’ refers to the electrode in an electrochemical cell/device/sensor on which the electrochemical reaction of interest is occurring. As used herein, the term ‘counter-electrode’ refers to the electrode used in an electrochemical cell for voltammetric analysis or other reactions in which an electric current is expected to flow. As used herein, the term ‘glassy carbon’ refers to the non-graphitizing carbon which combines glassy and ceramic properties with those of graphite.

The catalyst-modified GC electrodes were immersed in an electrolyte made of H₂SO₄ of 0.5 M. To make the modified working electrodes: Catalyst (4 mg) was mixed with 5% nafion solution (80 microliters (μL)) in 1 mL of ethanol and DIW (1:4 v/v). The fluid mixture was ultrasonicated for 20 minutes to get an ink suspension. Then, 5 μL (loading mass of ≈0.285 mg/cm²) of the suspension was dropped and cast at the top of the GC electrode, followed by drying at 65° C. for 2 hours using a linear sweep voltammetry (LSV) with a scan rate of 10 mV/s. The electrochemical impedance spectroscopy (EIS) measurement was performed at an AC voltage of 10 mV and frequencies in the range of 0.1-105 Hz for all electrodes operated in H₂SO₄ medium (0.5 M) at an overpotential of 0.227 V. The applied potential values were modified according to reversible hydrogen electrode (RHE) through the Nernst equation (E_{RHE}=E_{applied}+0.0591 pH+E⁰_{Ag/AgCl}, where E_{applied} is the applied potential against Ag/AgCl, E_{RHE} is the RHE potential, and E⁰Ag/AgCl is the reference Ag/AgCl potential which is 198 mV at 25° C.).

### Example 5: Characterizations

A Rigaku X-ray diffractometer (XRD) was used to determine the crystallinity and structures of the sample. The XRD pattern was recorded using Cu-Kα radiation of wavelength (2) of 0.1541 nm. Morphologies of the samples were imaged using a scanning electron microscope (SEM, Zeiss Company) attached to an energy dispersive X-ray (EDX) spectrometer and transmission electron microscope (TEM, Titan-FEI-Morgagni-268). X-ray photoelectron spectroscopy (XPS, Kratos DLD) was used to detect the presence of chemical elements in the samples.

### Example 6: Scheme of PLAL Process

As aforementioned, different concentrations of the PTNCs (Au@SrTiO₃/g-C₃N₄) were prepared using a one-step PLAL method. For this purpose, particles of the g-C₃N₄, an auric salt, and SrTiO₃ were sonicated (FIG. 3) for about 30 minutes to form a mixture (302). Further, a Q-switched ND:YAG laser (operated at 532 nm, pulse energy of 350 millijoules (mJ), pulse duration of 8 ns, pulse width of 9 ns, and repetition rate of 10 Hz) was used to ablate the target of auric chloride, SrTiO₃, and g-C₃N₄ each time [A. Ilyas, M. A. Gondal, Z. H. Yamani, U. Baig, Facile synthesis of titanium dioxide-cadmium sulfide nanocomposite using pulsed laser ablation in liquid and its performance in photovoltaic and photocatalytic applications, Int J Energy Res. 41 (2017) 1422-1435; M. Hassan, M. A. Gondal, E. Cevik, M. A. Dastageer, U. Baig, R. A. Moqbel, T. F. Qahtan, A. Bozkurt, N. al Abass, Laser assisted anchoring of cadmium sulfide nanospheres into tungsten oxide nanosheets for enhanced photocatalytic and electrochemical energy storage applications, Colloids Surf A Physicochem Eng Asp. 617 (2021) 126318, each incorporated herein by reference in their entirety]. The laser pulses were collimated on the target for approximately 20 minutes immersed in DIW. The Nd:YAG laser is immersed in water during operation to help dissipate the heat generated by the laser. When the laser is fired, it produces a significant amount of heat that can cause the crystal to crack or fail if not properly dissipated. Immersing the laser in water helps to absorb the heat and prevent damage to the crystal. During the ablation process, a plasma plume was generated through the initiation of photocatalytic reduction of the target materials followed by the anchoring of Au nanoparticles onto SrTiO₃/g-C₃N₄ surface. Consequently, the cavitation bubble was expanded, erupted, and created well-dispersed nanoparticles in the liquid suspension. The change in solution color indicated the formation of nanocomposites, suggesting the successful nucleation of Au, SrTiO₃, and g-C₃N₄ nanoparticles. The synthesized mixture need not be purified using any chemicals or catalysts, thus providing high-purity PTNCs of Au@SrTiO₃/g-C₃N₄.

### Example 7: XRD Patterns

FIG. 4 shows XRD profiles of bare g-C₃N₄, SrTiO₃, SrTiO₃/g-C₃N₄, and Au@SrTiO₃/g-C₃N₄ electrodes. The presence of intense XRD peaks clearly indicated their strong crystallinity. Diffraction peaks at 12.8° was indexed to (100) lattice plane corresponding to trigonal hydrogen bonds of tri-triazine units. A sharp peak at 27.3° was indexed as (002) plane corresponding to the stacking of the conjugated aromatic system like g-C₃N₄. These were matched with the JCPDS file No: 87-1526 [M. I. Chebanenko, N. v Zakharova, A. A. Lobinsky, V. I. Popkov, Ultrasonic-Assisted Exfoliation of Graphitic Carbon Nitride and its Electrocatalytic Performance in Process of Ethanol Reforming, Semiconductors. 53 (2019) 2072-2077, incorporated herein by reference in its entirety]. In addition, pure SrTiO₃ displayed intense peaks at 22.9°, 32.5°, 40.1°, 46.6°, 52.5°, 57.9°, 67.9°, and 77.3° due to Bragg diffraction from (100), (110), (111), (200), (210), (211), (220), and (310) lattice planes that matched with JCPDS file No: 35-0734 [V. v Deshmukh, C. R. Ravikumar, M. R. A. Kumar, S. Ghotekar, A. N. Kumar, A. A. Jahagirdar, H. C. A. Murthy, Structure, morphology and electrochemical properties of SrTiO₃ perovskite: Photocatalytic and supercapacitor applications, Environmental Chemistry and Ecotoxicology. 3 (2021) 241-248, incorporated herein by reference in its entirety]. Furthermore, the XRD peak of g-C₃N₄ was broader and less intense than the one obtained for SrTiO₃/g-C₃N₄ and Au@SrTiO₃/g-C₃N₄ which was due to the tinier size and weaker crystallinity of g-C₃N₄. Au@SrTiO₃/g-C₃N₄ showed intense XRD peaks at 38.3°, 44.6°, and 64.76° corresponding to the reflection from (111), (200), and (220) lattice planes of Au (JCPDS file No: 04-0784) [G. Geng, P. Chen, B. Guan, Y. Liu, C. Yang, N. Wang, M. Liu, Sheetlike gold nanostructures/graphene oxide composites via a one-pot green fabrication protocol and their interesting two-stage catalytic behaviors, RSC Adv. 7 (2017) 51838-51846, incorporated herein by reference in its entirety].

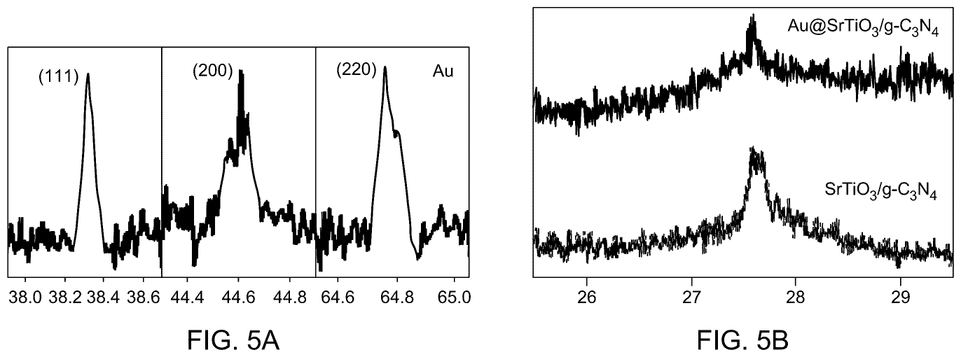

FIG. 5A (sharp peaks of g-C₃N₄ and Au) verified the existence of g-C₃N₄ and Au in Au@SrTiO₃/g-C₃N₄-based PTNCs. In addition, FIG. 5B shows the positions of XRD peaks of g-C₃N₄ in SrTiO₃/g-C₃N₄ and Au@SrTiO₃/g-C₃N₄ which was due to tinier size and weaker crystallinity of g-C₃N₄ in SrTiO₃/g-C₃N₄ and Au@SrTiO₃/g-C₃N₄, respectively. In addition, the positions of XRD peaks of SrTiO₃ in SrTiO₃/g-C₃N₄ and Au@SrTiO₃/g-C₃N₄ were unaffected due to the addition of Au and g-C₃N₄ indicating non-eradication of Au and g-C₃N₄ into the lattice structures of SrTiO₃ existed in the PTNCs.

### Example 8: Morphology Analysis

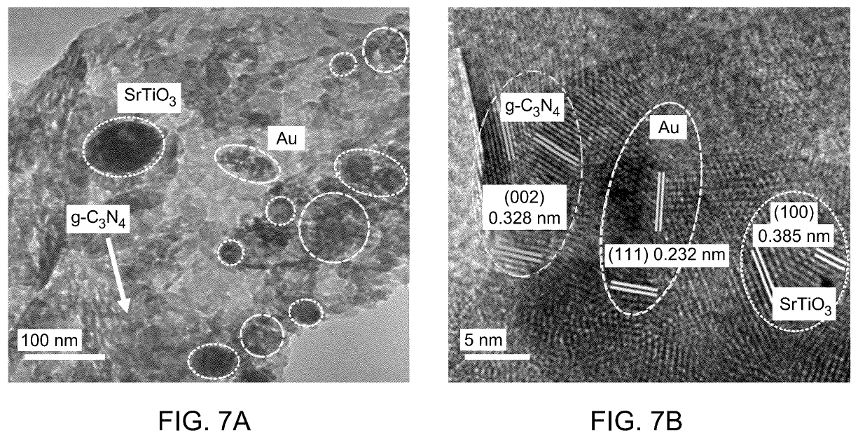

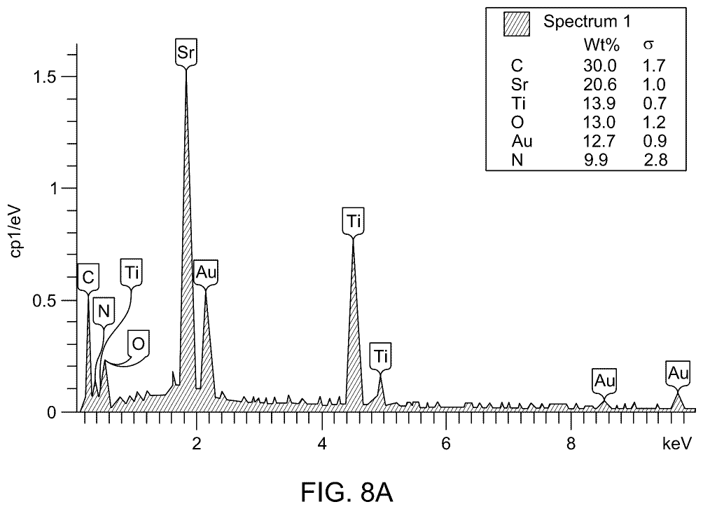

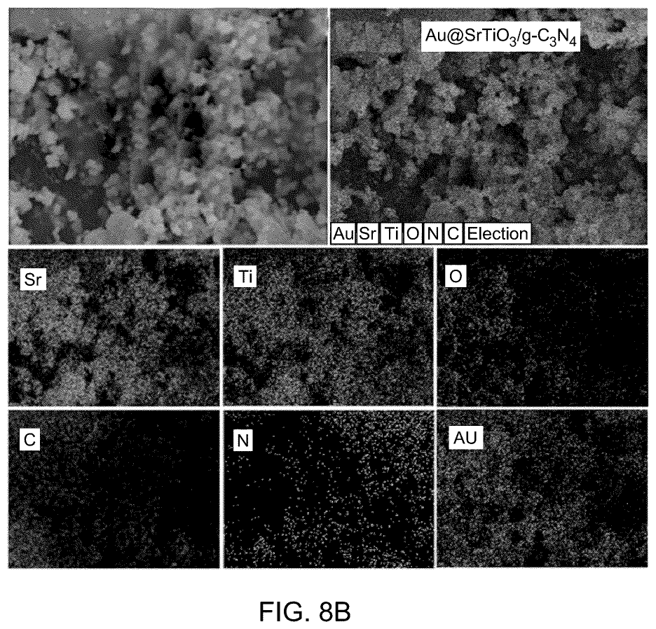

FIG. 6A-6D illustrate SEM micrographs of the proposed samples, which showed the nucleation of loosely bound layers with sheet-like structures of g-C₃N₄ (FIG. 6A), tiny spherical nanoparticles of SrTiO₃ (FIG. 6B), and very small spherical nanoparticles of Au (FIG. 6C). When Au and g-C₃N₄ were incorporated into SrTiO₃ (FIG. 6D), the Au, SrTiO₃, and g-C₃N₄ retained their original shapes. A TEM analysis was accomplished to afford a broad interpretation of the Au@SrTiO₃/g-C₃N₄ TNC architecture. FIGS. 7A-7B display TEM and HRTEM images of Au@SrTiO₃/g-C₃N₄, supporting the SEM results. The HRTEM image of Au@SrTiO₃/g-C₃N₄ TNC (FIG. 7B) verified the strong connectivity of Au, SrTiO₃, and g-C₃N₄ nanoparticles in the matrix. The recorded d-spacing of Au, g-C₃N₄, and SrTiO₃ obtained from the lattice fringes was 0.232, 0.328, and 0.385 nm, respectively, which corresponded to the lattice planes of (111), (002), and (100). EDX spectra and EDX elemental maps of Au@SrTiO₃/g-C₃N₄ indicated the presence of Au, Sr, Ti, O, C, and N (FIGS. 8A-8B). This observation confirmed the successful incorporation of Au and g-C₃N₄ into the lattice structure of SrTiO₃, confirming the high purity of the proposed PTNCs.

### Example 9: XPS Analysis

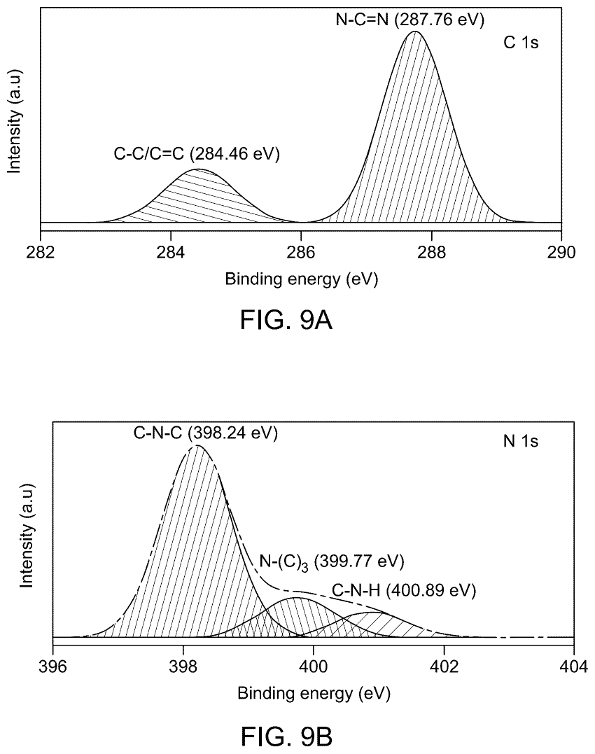

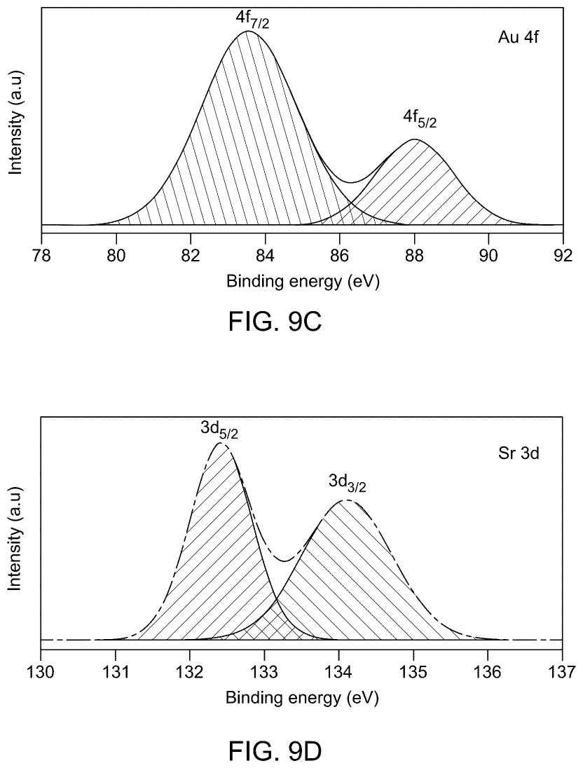

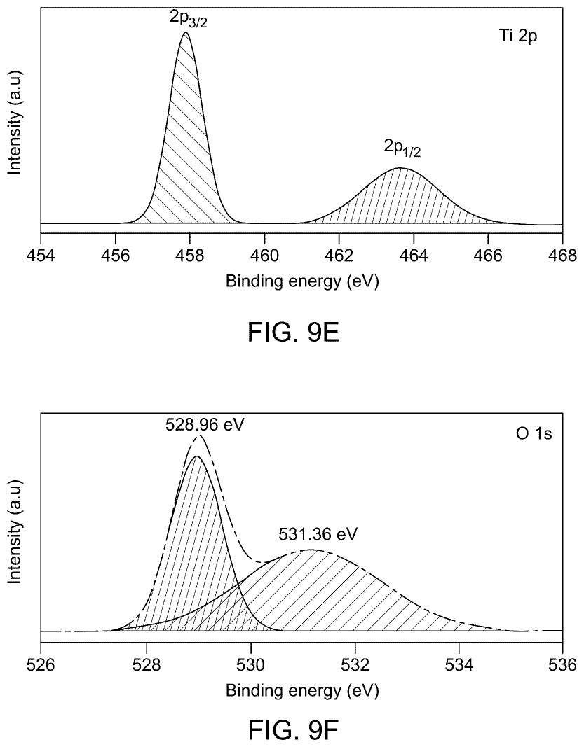

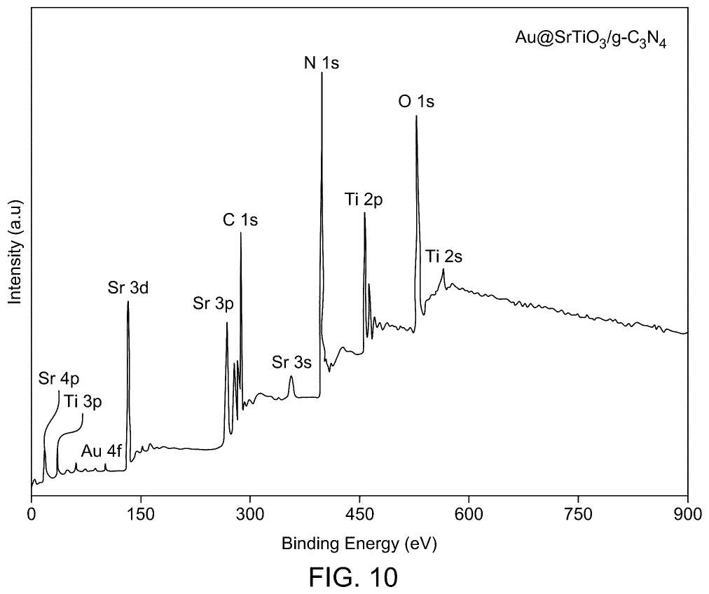

FIGS. 9A-9F show XPS core level spectra of Au@SrTiO₃/g-C₃N₄ with C 1s, N 1s, Au 4f, Sr 3d, Ti 2p, and O 1s profiles, indicating the chemical states of Au, Sr, Ti, O, C, and N in Au@SrTiO₃/g-C₃N₄ (FIG. 10). This observation verified the incorporation of Au and g-C₃N₄ in SrTiO₃ crystal unit cells. The binding energies of all the characteristic elements were adjusted relative to the reference peak of C 1s at 284.6 eV. The XPS profile of C 1s consisted of two peaks (FIG. 9A) at 284.46 and 287.76 eV due to C—C—/C═C and N—C═N linkages in g-C₃N₄ [L. Tan, J. Xu, X. Zhang, Z. Hang, Y. Jia, S. Wang, Synthesis of g-C₃N₄/CeO₂ nanocomposites with improved catalytic activity on the thermal decomposition of ammonium perchlorate, Appl Surf Sci. 356 (2015) 447-453, incorporated herein by reference in its entirety].

The XPS profiles N Is was comprised of three peaks at 398.24, 399.77, and 400.89 eV (FIG. 9B) corresponding to pyridyl-type C—N—C, pyrrolic-type N—(C)₃, and graphitic C—N—H of the N state moiety in g-C₃N₄ [Z. Huang, Q. Sun, K. Lv, Z. Zhang, M. Li, B. Li, Effect of contact interface between TiO₂ and g-C₃N₄ on the photoreactivity of g-C₃N₄/TiO₂ photocatalyst: (001) vs. (101) facets of TiO₂, Appl Catal B. 164 (2015) 420-427, incorporated herein by reference in its entirety]. The XPS spectra of Au 4f composed of two peaks (FIG. 9C) at 83.60 and 87.96 eV corresponding to Au 4f_{7/2} and Au 4f_{5/2} electronic states of Au⁰/Au⁺/Au³⁺[A. Yu. Klyushin, T. C. R. Rocha, M. Hävecker, A. Knop-Gericke, R. Schlögl, A near ambient pressure XPS study of Au oxidation, Physical Chemistry Chemical Physics. 16 (2014) 7881-7886, incorporated herein by reference in its entirety]. The two XPS peaks of Sr 3d (FIG. 9D) at 132.36 and 134.06 eV corresponded to the Sr 3d_{5/2} and Sr 3d_{3/2} states of Sr²⁺[A. Kumar, A. Rana, G. Sharma, Mu. Naushad, A. H. Al-Muhtaseb, C. Guo, A. Iglesias-Juez, F. J. Stadler, High-Performance Photocatalytic Hydrogen Production and Degradation of Levofloxacin by Wide Spectrum-Responsive Ag/Fe₃O₄ Bridged SrTiO₃/g-C₃N₄ Plasmonic Nanojunctions: Joint Effect of Ag and Fe₃O₄, ACS Appl Mater Interfaces. 10 (2018) 40474-40490, incorporated herein by reference in its entirety].

The XPS profile of Ti 2p showed two peaks at 457.96 and 463.76 eV (FIG. 9E) due to the Ti 2p_{3/2} and Ti 2p_{1/2} states of Ti⁴⁺. In addition, the energy difference between Ti 2p_{3/2} and Ti 2p_{1/2} peaks was 5.8 eV, indicating the existence of the Ti⁴⁺ state [S. Manchala, A. Gandamalla, V. N. Rao, S. M. Venkatakrishnan, V. Shanker, Solar-light responsive efficient H₂ evolution using a novel ternary hierarchical SrTiO₃/CdS/carbon nanospheres photocatalytic system, J Nanostructure Chem. 12 (2022) 179-191, incorporated herein by reference in its entirety]. The XPS spectra of O 1s (FIG. 9F) revealed a peak at 528.96 eV due to lattice oxygen of SrTiO₃, and the other peak at 531.36 eV corresponded to the oxygen vacancies-mediated chemisorbed oxygen in the TNCs matrix [J. Pan, Z. Chen, P. Wang, P. Wang, Q. Yu, W. Zhao, J. Wang, M. Zhu, Y. Zheng, C. Li, The overall water splitting of CdS/Ti³⁺—SrTiO₃ core-shell heterojunction via OER enhancement of MnOx nanoparticles, Chemical Engineering Journal. 424 (2021) 130357; Y. Qin, F. Fang, Z. Xie, H. Lin, K. Zhang, X. Yu, K. Chang, La, Al-Codoped SrTiO₃ as a Photocatalyst in Overall Water Splitting: Significant Surface Engineering Effects on Defect Engineering, ACS Catal. 11 (2021) 11429-11439, each incorporated herein by reference in their entirety]. Briefly, the XPS results strongly supported the coexistence of Au, g-C₃N₄, and SrTiO₃ in the Au@SrTiO₃/g-C₃N₄ TNCs.

### Example 10: EHER Performance

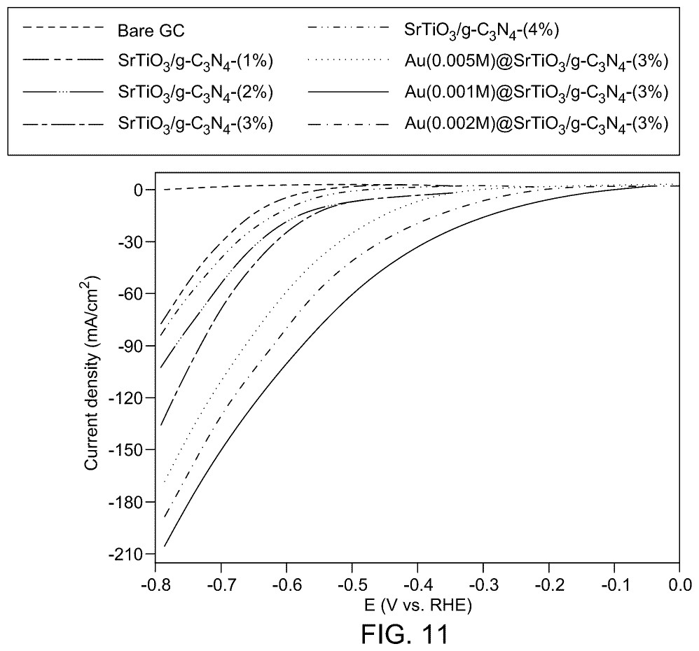

In a three-electrode setup, cathodic polarization curves were used to evaluate the EHER performance of the produced electrodes immersed in the acidic medium (0.5 M of H₂SO₄). FIG. 11 shows the effect of g-C₃N₄ on SrTiO₃ for the EHER. It was observed that the addition of g-C₃N₄ enhanced the current density of the nanocomposite at a sufficiently low overpotential. First, with the increase of g-C₃N₄ content, the EHER activity was improved, wherein the current density (J) was increased to −10 mA/cm² at an over-potential of −0.508 V for SrTiO₃/g-C₃N₄-(3%). Afterwards, the HER activity was reduced with a further increase of g-C₃N₄ in SrTiO₃. This reduction was mainly due to the sheathing of g-C₃N₄ in the active edges of SrTiO₃, increasing the number of recombination centers rather than producing further active edges. SrTiO₃/g-C₃N₄-(3%) TNC showed the HER activity due to a higher loading mass of g-C₃N₄ onto the SrTiO₃ surface. In addition, the impact of Au concentration on optimized SrTiO₃/g-C₃N₄-(3%) for HER was also examined. The results showed that the loading concentration of Au (0.001 M) on SrTiO₃/g-C₃N₄-(3%) achieved an improved HER activity compared to all other electrodes.

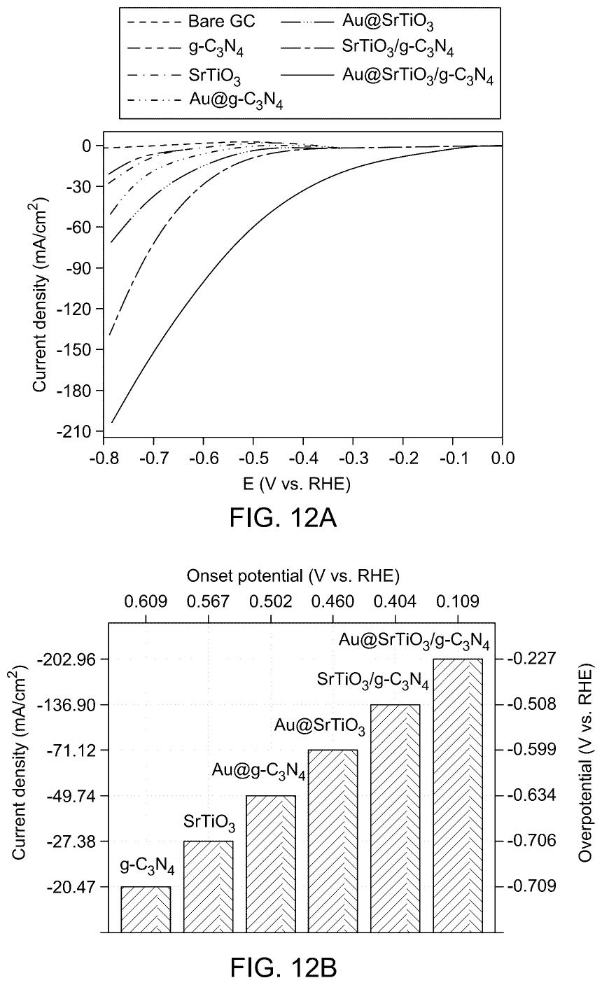

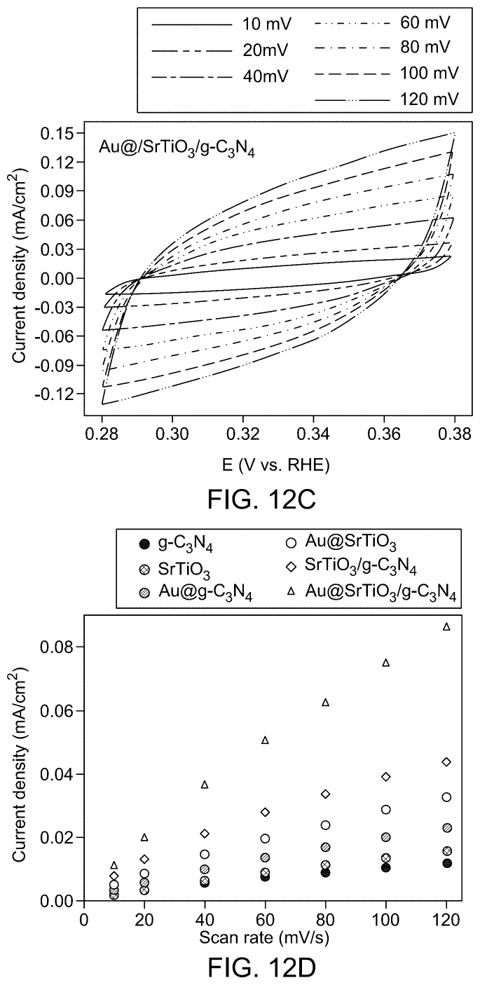

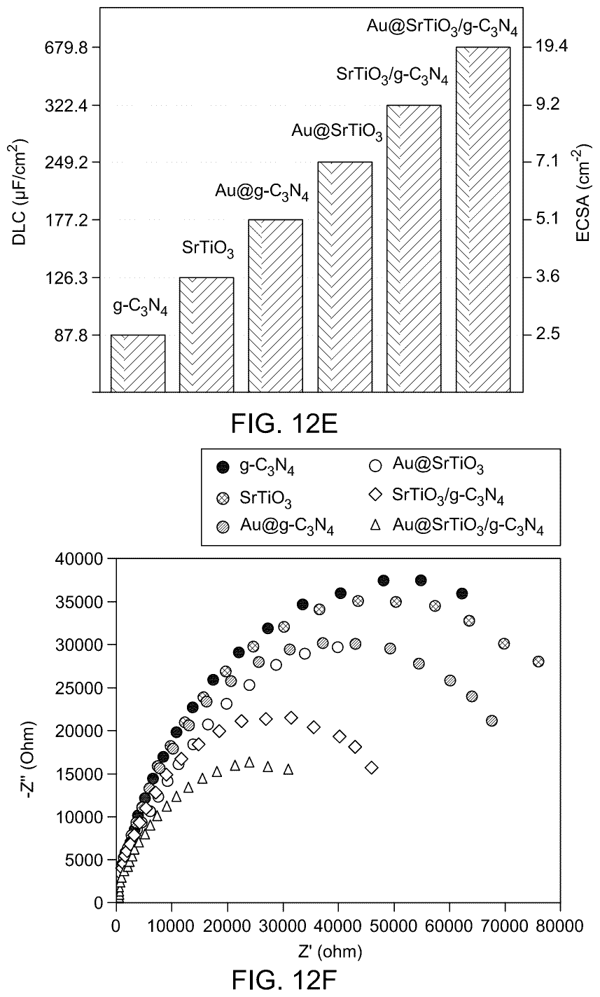

FIG. 12A displays LSV of Au@SrTiO₃/g-C₃N₄ electrode with different concentrations of loaded catalysts. The electrodes consisting of SrTiO₃ and g-C₃N₄ exhibited inferior EHER activity under the applied circumstances in comparison to the EHER activity exhibited by the electrode consisting of SrTiO₃/g-C₃N₄. For instance, an over-potential of −0.709, −0.706, and −0.508 V were obtained corresponding to the g-C₃N₄, SrTiO₃, and SrTiO₃/g-C₃N₄ electrodes, respectively, demonstrating J=−10 mA/cm². This observation reaffirmed the successful incorporation of Au into the SrTiO₃/g-C₃N₄ composites. The catalytic performance of Au@SrTiO₃/g-C₃N₄ was improved that achieved the lowest value of over-potential of −0.227 V and highest J=−202.96 mA/cm². The over-potential required for Au@g-C₃N₄ and Au@SrTiO₃ electrodes was correspondingly −0.634 and −0.599 V to achieve J=−10 mA/cm². The value of J for Au@SrTiO₃/g-C₃N₄ PTNC was higher than other catalysts in the studied potential region, indicating the high performance of the proposed nanocomposite as cathode material. This improvement in the catalytic activity of PTNCs was mainly due to an abundance of active sites created by Au attachment on the SrTiO₃/g-C₃N₄ surface. FIG. 12B shows the variation of current density, over-potential, and onset potential histogram of various studied electrodes.

FIG. 12C shows CVs (in the non-faradic region) of Au@SrTiO₃/g-C₃N₄ electrode in H₂SO₄ (0.5 M) at scan rate ranging from 10-120 mV/s. The CVs validated the existence of the most active surface area of Au@SrTiO₃/g-C₃N₄ electrode. Double-layer capacitance (DLC) was used to compute electrochemical surface area (ECSA). The values of DLC show direct proportionality to ECSA (ECSA=DLC/Cs, where Cs is specific capacitance of the electrode material) in the absence of any Faradic current in the studied region [X. Zhang, W. Gu, E. Wang, Wire-on-flake heterostructured ternary Co0.5Ni0.5P/CC: an efficient hydrogen evolution electrocatalyst, J Mater Chem A Mater. 5 (2017) 982-987, incorporated herein by reference in its entirety]. FIG. 12D shows the estimation of DLC values at 0.33 from the slope through linear fit of current. FIG. 12E depicts DLC and ECSA histogram for various electrodes. The DLC value of Au@SrTiO₃/g-C₃N₄ (679.8 microfarads per square centimeter (μF/cm²)) was 7.7, 5.4, 3.8, 2.7, and 2.1 times higher than the one obtained for electrodes made correspondingly from g-C₃N₄ (87.8 μF/cm²), SrTiO₃ (126.3 μF/cm²), Au@g-C₃N₄ (177.2 μF/cm²), Au@SrTiO₃ (249.2 μF/cm²) and SrTiO₃/g-C₃N₄ (322.4 μF/cm²). These findings affirmed that incorporating Au into SrTiO₃/g-C₃N₄ composite could appreciably improve the value of ECSA that is directly correlated to DLC. Furthermore, the ECSA value of Au@SrTiO₃/g-C₃N₄ (19.4 cm²) electrode calculated following [Z. Zhou, L. Wei, Y. Wang, H. E. Karahan, Z. Chen, Y. Lei, X. Chen, S. Zhai, X. Liao, Y. Chen, Hydrogen evolution reaction activity of nickel phosphide is highly sensitive to electrolyte pH, J Mater Chem A Mater. 5 (2017) 20390-20397, incorporated herein by reference in its entirety] was larger compared to those made from g-C₃N₄ (2.5 cm²) SrTiO₃ (3.6), Au@g-C₃N₄ (5.1 cm²), Au@SrTiO₃ (7.1 cm²), and SrTiO₃/g-C₃N₄ (9.2 cm²), respectively. The inclusion of Au into the SrTiO₃/g-C₃N₄ NC matrix could enhance the ECSA of Au@SrTiO₃/g-C₃N₄, validating the hypothesis that Au can boost the active sites for electrochemical EHER at the Au@SrTiO₃/g-C₃N₄ electrode surface. 5 The EIS measurement was performed to understand the kinetics of charge transfer at the interface of semiconductor and electrolyte due to high EHER activity of the proposed Au@SrTiO₃/g-C₃N₄ catalyst [S. Nong, W. Dong, J. Yin, B. Dong, Y. Lu, X. Yuan, X. Wang, K. Bu, M. Chen, S. Jiang, L.-M. Liu, M. Sui, F. Huang, Well-Dispersed Ruthenium in Mesoporous Crystal TiO₂ as an Advanced Electrocatalyst for Hydrogen Evolution Reaction, J Am Chem Soc. 140 (2018) 5719-5727, incorporated herein by reference in its entirety]. FIG. 12F shows Nyquist plots of the studied electrodes wherein the presence of small semi-circle signified a rapid transfer of electrons at the interface between the catalyst and electrolyte, indicating a high electrocatalytic activity of the proposed PTNCs-based electrode. The Au@SrTiO₃/g-C₃N₄ catalyst showed substantially lesser charge transfer resistance than other studied catalysts. In addition, the improved EHER catalytic performance of Au@SrTiO₃/g-C₃N₄ indicated its higher capacity for electron transfers at the interface of electrocatalyst and electrolyte due to the addition of Au in SrTiO₃/g-C₃N₄. This observation was consistent with the I-V results and DLC plots (FIG. 12A and FIG. 12E).

Table 1 shows the values of various HER parameters for the proposed electrodes. The EHER catalytic activity of the Au@SrTiO₃/g-C₃N₄-decorated PTNCs as electrocatalysts outperformed the existing state-of-the-art electrodes (Table 2). The values of HER parameters like current density, onset potential, overpotential, DLC, ECSA, and Tafel slope for the proposed PTNCs was better compared to other findings.

TABLE 1
Values of obtained HER parameters for the studied samples

| | Current | Overpotential | Onset | Tafel | | |
|---|---|---|---|---|---|---|
| | density | (V) at −10 | potential | slope | DLC | ECSA |
| Catalysts | (mA/cm²) | mA/cm² | (V) | (mV/dec) | (μF/cm²) | (cm²) |
| g-C₃N₄ | 20.47 | 0.709 | 0.609 | 165.46 | 87.8 | 2.5 |
| SrTiO₃ | 27.38 | 0.706 | 0.567 | 158.25 | 126.3 | 3.6 |
| Au@g-C₃N₄ | 49.74 | 0.634 | 0.502 | 129.89 | 177.2 | 5.1 |
| Au@SrTiO₃ | 71.12 | 0.599 | 0.460 | 113.70 | 249.2 | 7.1 |
| SrTiO₃/g-C₃N₄ | 136.90 | 0.508 | 0.404 | 92.39 | 322.4 | 9.2 |
| Au@SrTiO₃/g-C₃N₄ | 202.96 | 0.227 | 0.109 | 62.36 | 679.8 | 19.4 |

TABLE 2
The comparison of electrocatalytic HER performance
of Au@SrTiO₃/g-C₃N₄ with other HER
catalysts in an acidic medium published in the art

| | Overpotential (V) | Tafel slope |
|---|---|---|
| Catalysts | at −10 mA/cm² | (mV/dec) |
| Au@SrTiO₃/g-C₃N₄ | 0.227 | 62.36 |
| MoS₂ dots on Au | 0.2 V | 82 |
| N, P-graphene | 0.420 | 91 |
| Cu₃P@NPPC-650 | 0.292 | 76 |
| Mo₂C/CC | 0.140 | 124 |
| MoS₂/CoS₂/CC | 0.087 | 73.4 |
| Co₉S₈/CoS_{1.097}/rGO | 0.188 | 96 |
| WC/CNT | 0.250 | 78 |
| Ni-CeO₂Gd/CF | 0.160 | 102 |
| CoS/MoS₂ | 0.253 | 106 |
| WSe₂-CFP | 0.300 | 77.4 |
| Co₉S₈@MoS₂@CNFs | 0.190 | 110 |

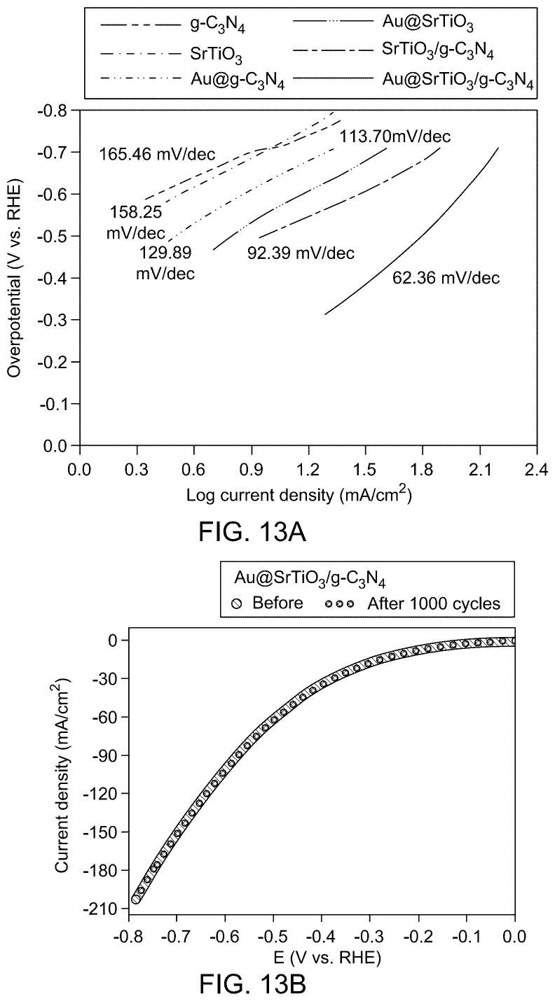

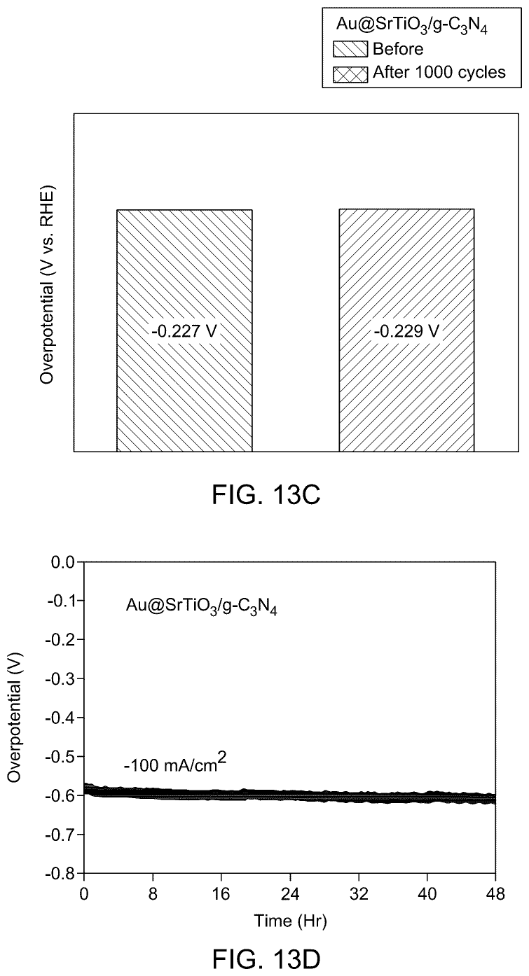

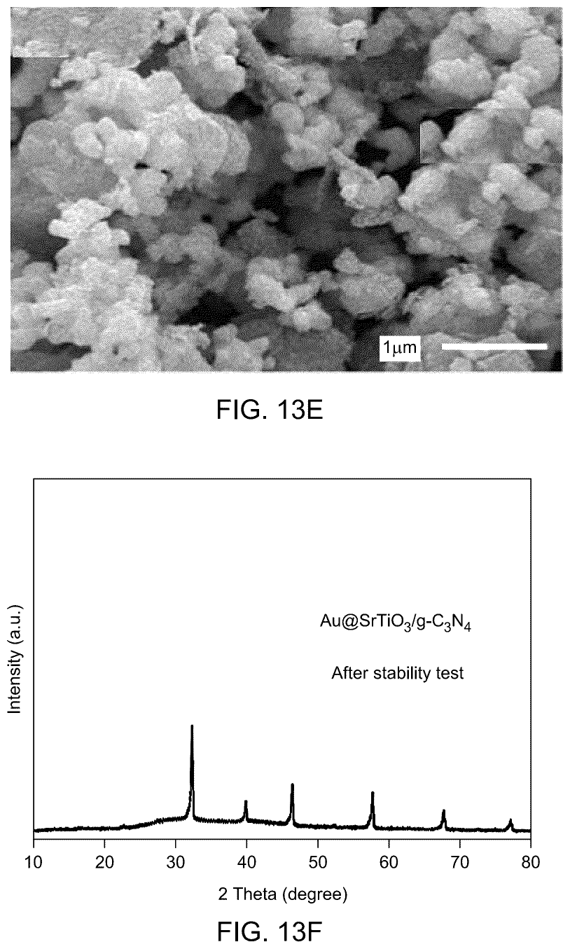

FIG. 13A-FIG. 13E show the Tafel plot of various electrodes, LSV curves of Au@SrTiO₃/g-C₃N₄ before and after 1000 successive scan, chronopotentiometry curve (in 0.5 M of H₂SO₄) of Au@SrTiO₃/g-C₃N₄ at J=−100 mA/cm² together with SEM image and XRD pattern of Au@SrTiO₃/g-C₃N₄ after stability test. Au@SrTiO₃/g-C₃N₄ electrode displayed (FIG. 13B) the superposition of LSV curves for the 1st and 1000th cycles, thus retaining almost the same over-potential (FIG. 13C). This result indicated the improved stability of EHER operated with the proposed electrode. In addition, the long-term stability of Au@SrTiO₃/g-C₃N₄ electrode was confirmed by measuring the stability after 48 hours of continuous operation at −100 mA/cm². FIG. 13D displays the 0.598 V vs RHE potential needed to achieve a current density of −100 mA/cm². This observation suggests the prospect of Au@SrTiO₃/g-C₃N₄ electrode in EHER application. The mechanism behind improved EHER activity of the proposed Au@SrTiO₃/g-C₃N₄ electrode could be understood from the Tafel plots. The slope of the Tafel curve for the as prepared electrocatalytic materials was calculated from η=a+b×log (J) (where a and b are the corresponding Tafel constant and slope; J is the current density, and η is the over-potential) [M. J. S. Mohamed, High bifunctional electrocatalytic activity of FeWO4/Fe₃O₄@NrGO nanocomposites towards electrolyzer and fuel cell technologies, Journal of Electroanalytical Chemistry. 897 (2021) 115587, incorporated herein by reference in its entirety].

The values of Tafel slopes for g-C₃N₄, SrTiO₃, Au@g-C₃N₄, Au@SrTiO₃, SrTiO₃/g-C₃N₄, and Au@SrTiO₃/g-C₃N₄ were correspondingly found to be 165.46, 158.25, 129.89, 113.70, 92.39, and 62.36 mV/dec (FIG. 13A). The Au@SrTiO₃/g-C₃N₄ electrocatalyst showed the smaller value of Tafel slope than other electrocatalysts, confirming that the addition of Au into SrTiO₃/g-C₃N₄ was crucial for enhancing the EHER performance of the cell. It is needless to mention that the Tafel slope has widely been used to validate the EHER mechanism and reaction-rates determining stages. In addition, the SEM and XRD analyses of the electrocatalyst were performed after the stability test of Au@SrTiO₃/g-C₃N₄ (FIG. 13E and FIG. 13F), confirming the clustering of catalyst particles with almost identical properties as before. No change in the crystalline structure was observed, indicating improved stability of Au@SrTiO₃/g-C₃N₄ electrocatalyst, thus ensuring an interrupted EHER performance. It can be concluded that the Au@SrTiO₃/g-C₃N₄ PTNCs of the present disclosure may be an emergent low-cost and stable electrode material for large-scale water electrolysis in hydrogen-based fuel cell technologies.

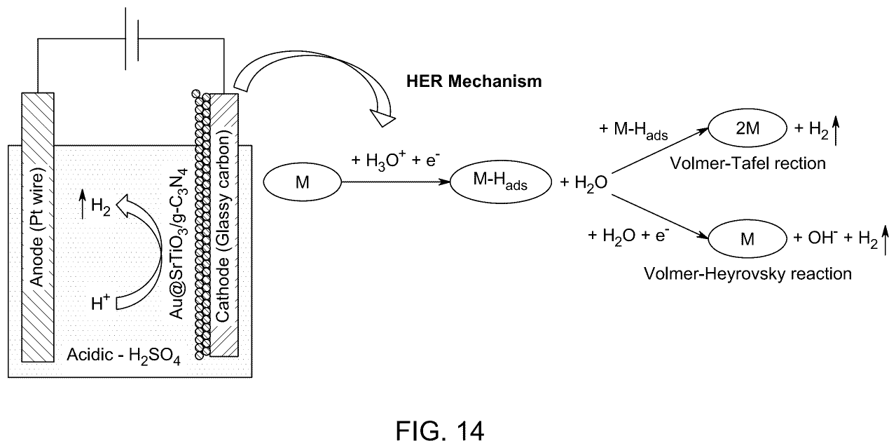

FIG. 14 shows the proposed mechanism of EHER activity of the PTNC electrode when operated in the acidic media. The Volmer, Heyrovsky, and Tafel processes are potential routes for converting atomic H into H molecules. A combination of the Volmer process with Tafel or Heyrovsky may lead to the creation of molecular hydrogen. The rate-determining stage is considered to be followed by the Volmer mechanism when the value of slope is ≈120 mV/dec. The rate-determining stage is considered to be followed by either Heyrovsky or Tafel mechanism when the value of slope is approximately 40 or 30 mV/dec, respectively [J. Benson, M. Li, S. Wang, P. Wang, P. Papakonstantinou, Electrocatalytic Hydrogen Evolution Reaction on Edges of a Few Layer Molybdenum Disulfide Nanodots, ACS Appl Mater Interfaces. 7 (2015) 14113-14122, incorporated herein by reference in its entirety]. The present findings of the Tafel slope (62.36 mV/dec) for Au@SrTiO₃/g-C₃N₄ electrocatalysts clearly indicate that the rate-determining stage was due to Volmer-Heyrovsky mechanism.

The TNC showed high electrocatalytic EHER capacity in an acidic medium (0.5 M of H₂SO₄). As the g-C₃N₄ content was increased in SrTiO₃, the EHER activity was also improved. The electrode consisting of SrTiO₃/g-C₃N₄-(3%) showed the optimum current density of −10 mA/cm² at an over-potential of −0.508 V. The reduction in the EHER activity with the further increase of g-C₃N₄ contents in SrTiO₃ was attributed to the g-C₃N₄ sheath of the active edges of the SrTiO₃ that, in turn boosted the recombination centers rather than producing further active edges needed for enhanced HER activity. The impact of Au concentration on the optimized SrTiO₃/g-C₃N₄-(3%) electrode for EHER operation was also evaluated. SrTiO₃/g-C₃N₄-(3%) electrode containing 0.001 M Au loading exhibited an outstanding EHER performance. The Au-incorporated SrTiO₃/g-C₃N₄ PTNCs displayed the highest EHER activity and stability with very low over-potential of 0.227 V, demonstrating a maximum cathodic current density of −202.96 mA/cm². which was 2-10 times higher than that of other electrodes. The achieved Tafel slope of 62.36 mV/decade indicated the dominance of the combined Volmer/Heyrovsky process in the EHER cycle for Au@SrTiO₃/g-C₃N₄ TNCs surface. The obtained improved EHER performance of Au@SrTiO₃/g-C₃N₄ PTNCs was mainly due to the enhanced intrinsic electrocatalytic kinetics and synergism of Au, SrTiO₃, and g-C₃N₄ interactions. It is established that the present Au@SrTiO₃/g-C₃N₄ PTNCs cathode materials are an efficient HER electrocatalyst can be beneficial for hydrogen-based fuel cell technologies, thus solving the acute energy crises without harming the environment.

Numerous modifications and variations of the present disclosure are possible in light of the above teachings. It is therefore to be understood that within the scope of the appended claims, the invention may be practiced otherwise than as specifically described herein.

1. An electrode, comprising:
a transparent substrate; and
a layer of a perovskite-based nanocomposite (PTNC) material at least partially covering a surface of the transparent substrate;
wherein the PTNC material comprises gold (Au) nanoparticles, graphitic carbon nitride (g-C₃N₄) nanoparticles, and perovskite-based nanoparticles.

2. The electrode of claim 1, wherein the transparent substrate is a glass substrate, and wherein the glass substrate is at least one selected from the group consisting of a fluorine doped tin oxide (FTO) glass substrate, a tin doped indium oxide (ITO) glass substrate, an aluminum doped zinc oxide (AZO) glass substrate, a niobium doped titanium dioxide (NTO) glass substrate, an indium doped cadmium oxide (ICO) glass substrate, an indium doped zinc oxide (IZO) glass substrate, a fluorine doped zinc oxide (FZO) glass substrate, a gallium doped zinc oxide (GZO) glass substrate, an antimony doped tin oxide (ATO) glass substrate, a phosphorus doped tin oxide (PTO) glass substrate, a zinc antimonate glass substrate, a zinc oxide glass substrate, a ruthenium oxide glass substrate, a rhenium oxide glass substrate, a silver oxide glass substrate, and a nickel oxide glass substrate.

3. The electrode of claim 1, wherein the transparent substrate is a FTO glass substrate.

4. The electrode of claim 1, wherein the Au nanoparticles present in the PTNC material are spherical nanoparticles having an average diameter of 5 to 50 nanometers (nm), and an interplanar spacing d(111) of the (111) plane in a range of 0.15 to 0.3 nm as determined by X-ray diffraction.

5. The electrode of claim 1, wherein the g-C₃N₄ nanoparticles present in the PTNC material are nanosheets having an average thickness of 1 to 20 nm, and an interplanar spacing d(002) of the (002) plane in a range of 0.25 to 0.35 nm as determined by X-ray diffraction.

6. The electrode of claim 1, wherein the perovskite-based nanoparticles present in the PTNC material are spherical nanoparticles having an average diameter of 50 to 200 nm, and an interplanar spacing d(100) of the (100) plane in a range of 0.35 to 0.45 nm as determined by X-ray diffraction.

7. The electrode of claim 1, wherein the PTNC material comprises 20 to 40 wt. % carbon, 10 to 30 wt. % strontium, 10 to 30 wt. % titanium, 10 to 30 wt. % zirconium, 10 to 30 wt. % barium, 10 to 30 wt. % niobium, 10 to 30 wt. % lanthanum, 10 to 30 wt. % manganese, 10 to 30 wt. % aluminum, 10 to 20 wt. % oxygen, 10 to 20 wt. % gold, and 5 to 15 wt. % nitrogen, each wt. % based on a total weight of the PTNC material by energy dispersive X-ray (EDX).

8. The electrode of claim 1, having a current density of 150 to 250 milliamperes per square centimeter (mA/cm²) in an acidic medium at a scan rate of 5 to 20 millivolts per second (mV/s).

9. The electrode of claim 1, having an overpotential of 0.1 to 0.3 volts (V) in an acidic medium at a scan rate of 5 to 20 mV/s.

10. The electrode of claim 1, having a Tafel slope of 40 to 80 millivolts per decade (mV/decade) in an acidic medium at a scan rate of 5 to 20 mV/s.

11. A method of making the electrode of claim 1, comprising:
preparing the PTNC material by:
grinding and mixing urea and melamine to form a first mixture;
calcining the first mixture at a temperature of at least 550° C. to form the g-C₃N₄;
mixing and dispersing particles of the g-C₃N₄, an auric salt, and a perovskite-based material in water to form a second mixture;
sonicating and homogenizing the second mixture to form a resultant mixture;
irradiating the resultant mixture with a pulsed laser beam at a wavelength of 520 to 540 nm and a pulse duration of 8 nanoseconds (ns) under continuous agitation to form a third mixture; and
heating the third mixture at a temperature of at least 90° C. to form the PTNC material.

12. The method of claim 11, wherein a weight ratio of the urea and melamine is in a range of 1:10 to 10:1.

13. The method of claim 11, wherein the auric salt comprises at least one of auric chloride, auric sodium chloride, potassium auric cyanide, and its hydrate.

14. The method of claim 11, wherein the perovskite-based material comprises at least one of SrTiO₃, SrZrO₃, BaTiO₃, BaSrTiO₃, SrNbTiO₃, BaCaTiO₃, LaMnO₃ and LaAlO₃.

15. The method of claim 11, further comprising:
coating the transparent substrate by:
mixing the PTNC material, a sulfonated polymer and a solvent mixture to form a fourth mixture;
sonicating the fourth mixture to form a coating composition; and
drop casting the coating composition onto a surface of the transparent substrate and drying to form the electrode having the layer of the PTNC material at least partially covered on the surface of the transparent substrate.

16. The method of claim 15, wherein the sulfonated polymer comprises at least one of Nafion, sulfonated poly(ether ether ketone) (SPEEK), sulfonated polyimide, sulfonated poly(phenylene oxide) (PPO), sulfonated poly(arylene ether sulfone), and sulfonated poly(4-phenoxybenzoyl-1,4-phenylene).

17. The method of claim 15, wherein the solvent mixture comprises at least one organic solvent selected from the group consisting of a ketone solvent, an ester solvent, an alcohol solvent, an amide solvent, and an ether solvent.

18. The method of claim 15, wherein the solvent mixture comprises an alcohol solvent and water, and wherein a volume ratio of the alcohol solvent and water is in a range of 1:1 to 1:10.

19. A method for electrochemical water splitting, comprising:
applying a potential between an anode and a cathode in an electrochemical cell containing an electrolyte to form hydrogen and oxygen;
wherein the cathode comprises the electrode of claim 1; and
wherein the electrolyte comprising an aqueous solution of an acid at a concentration of 0.001 to 3 molars (M).

20. The method for claim 19, wherein the acid comprises at least one of sulfuric acid, nitric acid, phosphoric acid, boric acid, and citric acid.
